(19) United States
(12) Patent Application Publication
(10) Pub. No.: US 2026/0326712 A1
(43) Pub. Date: Oct. 22, 2026

(54) METHODS AND APPARATUS TO DISABLE A VEHICLE AFTER THEFT

(71) Applicant: CARKEEPS, LLC, Fort Myers, FL (US)

(72) Inventors: Thomas Richard Harabasz, Glen Ellyn, IL (US); Sher Madanjit Singh, Chicago, IL (US)

(21) Appl. No.: 19/649,823

(22) Filed: Apr. 16, 2026

Related U.S. Application Data
(60) Provisional application No. 63/790,941, filed on Apr. 18, 2025.

(51) Int. Cl. B60R 25/042; B60R 25/10; B60R 25/20; B60R 25/34

(52) U.S. Cl. CPC B60R 25/042; B60R 25/10; B60R 25/20; B60R 25/34

(57) ABSTRACT

Methods and apparatus to disable a vehicle after theft are disclosed herein. An example system disclosed herein includes a system including a receiver connected to a user interface, and a controller including a first connection to be connected to the receiver, a second connection to be connected to a fuel box of a vehicle, the fuse box coupled to a fuel pump of the vehicle, and a relay to disable the fuel pump of the vehicle.

### RELATED APPLICATION

This patent claims the benefit of U.S. Provisional Patent Application No. 63/790,941, which was filed on Apr. 18, 2025. U.S. Provisional Patent Application No. 63/790,941 is incorporated herein by reference in its entirety. Priority to U.S. Provisional Patent Application No. 63/790,941 is claimed.

### FIELD OF THE DISCLOSURE

This disclosure relates generally to vehicle theft prevention and, more particularly, to methods and apparatus to disable a vehicle after theft.

### BACKGROUND

Vehicles often include anti-theft systems to deter and/or prevent theft from criminals. Some vehicles include alarms that activate when someone tries to gain unauthorized access to a vehicle. Such systems can be triggered in response to a vehicle door being forced open, the vehicle being tilted, window glass being broken, and/or can be activated manually by a user of the vehicle. Some vehicles include smart keys that inhibit the operation of the vehicle if the smart key is not physically within the vehicle. Many vehicle users also install steering wheel locks, which prevent rotation of the steering wheel while installed.

### BRIEF DESCRIPTION OF THE DRAWINGS

FIG. 1A is a side view of a vehicle including an anti-theft system implemented in accordance with teachings of this disclosure.

FIG. 1B is a diagram of the anti-theft system of FIG. 1A including an anti-theft controller.

FIG. 2 is an example electrical schematic diagram of one example implementation of the anti-theft system of FIGS. 1A and 1B.

FIG. 3A is a perspective view of an example assembly that can implement the receiver module of FIGS. 1A, 1B, and 2.

FIG. 3B is a perspective view of an interior of the assembly of FIG. 3A.

FIG. 4 is a perspective view of a plurality of connectors that may be coupled to the assembly of FIGS. 3A and 3B.

FIG. 5 is a flow diagram of example operations that can be used to mount the assembly 300 of FIGS. 3A, 3B, and 4 to a vehicle.

FIG. 6 is a block diagram of an example implementation of the anti-theft controller of FIG. 1B.

FIGS. 7 and 8 are flowcharts representative of example machine readable instructions and/or example operations that may be executed, instantiated, and/or performed by example programmable circuitry to implement the anti-theft controller of FIG. 6.

FIG. 9 is a block diagram of an example processing platform including programmable circuitry structured to execute, instantiate, and/or perform the example machine readable instructions and/or perform the example operations of FIGS. 7 and 8 to implement the anti-theft controller of FIG. 6.

FIG. 10 is a block diagram of an example implementation of the programmable circuitry of FIG. 9.

FIG. 11 is a block diagram of another example implementation of the programmable circuitry of FIG. 9.

In general, the same reference numbers will be used throughout the drawing(s) and accompanying written description to refer to the same or like parts. The figures are not necessarily to scale.

### DETAILED DESCRIPTION

In recent years, the number of automobile thefts has increased to over one million per year. Some such automobile thefts are carjackings, in which an automobile is stolen while in operation. Another type of automobile theft is motor theft, in which a vehicle is stolen while not in operation. Prior means of preventing automobile thefts, such as alarm systems, key fob proximity requirements, and kill switches, are effective at preventing thieves from successfully stealing an automobile. Particularly, these anti-theft technologies prevent thieves from operating vehicles during an attempted theft. Because the thieves are unable to leave the scene of the theft with a stolen vehicle, these prior anti-theft technologies leave the thieves in close proximity to the prior (authorized) user of the automobile during carjackings. This proximity leaves the authorized user vulnerable to physical retaliation from the thief. Other technologies, such as stolen vehicle recovery systems that use global positioning system (GPS) and/or cellular networks, are effective at locating stolen vehicles but do not prevent the original theft thereof.

As used herein, a “vehicle” includes anything used for transportation or for carrying goods, powered by a motive element (such as, for example, a combustion engine or an electric motor), and designed to operate on land and/or water. As used herein, “carjacking” refers to the theft of the vehicle while the vehicle is in operation by an authorized user of the vehicle (e.g., a robbery of a vehicle, etc.). As used herein, “motor theft” refers to the theft of a parked vehicle while the vehicle is not in operation by an authorized user. As used herein, an “authorized user” of a vehicle is the owner of the vehicle or a person given permission to operate the vehicle therefrom. As used herein, the terms “thief” and “unauthorized user” are used interchangeably to refer to operators of a vehicle who are not authorized users. As used herein, a component is “stock” if the component is (1) included with a vehicle when originally manufactured by an original equipment manufacturer (OEM) or (2) is an equivalent replacement component thereto.

Examples disclosed overcome some or all of the above-noted deficiencies and include methods and apparatus to disable the operation of a vehicle after theft. Examples disclosed herein include an anti-theft system that disables a key component of a vehicle and activates an alarm after a threshold time from the theft of the vehicle. Some example anti-theft systems disclosed herein disable the fuel pump of the vehicle to prevent further operation thereof. Some example anti-theft systems disclosed herein include a user interface positioned in the passenger compartment of the vehicle and a receiver module positioned adjacent to a fuse box of a vehicle. Additionally or alternatively, in some examples, a user interface is provided via a portable device (e.g., a smartphone, a tablet, an electronic fob, etc.) connected to the receiver module (e.g., directly paired via BLUETOOTH® or BLUETOOTH LOW ENERGY (BLE), indirectly connected over the Internet and/or through a cellular network, etc.). In some such examples, the user interface is provided via a mobile application that operates on the portable device of the authorized user. Some example anti-theft systems disclosed herein operate in an anti-carjacking mode, in which the fuel pump of a vehicle is disabled a threshold time after the user interface is activated. Some example anti-theft systems disclosed herein operate in an anti-motor theft mode, in which the fuel pump of a vehicle is disabled a threshold time after the ignition of a vehicle. Some example anti-theft systems disclosed herein do not disable the fuel pump of the vehicle if the user interface receives an input after the anti-theft system has been engaged (e.g., by an original input to the user interface, by vehicle ignition, etc.). Some examples disclosed herein enable the brief operation of a vehicle after the theft thereof, which can create distance between the thief and the authorized user of the vehicle. The distance between the thief and the authorized user of the vehicle reduces the likelihood of physical retaliation from the thief and injury to the authorized user.

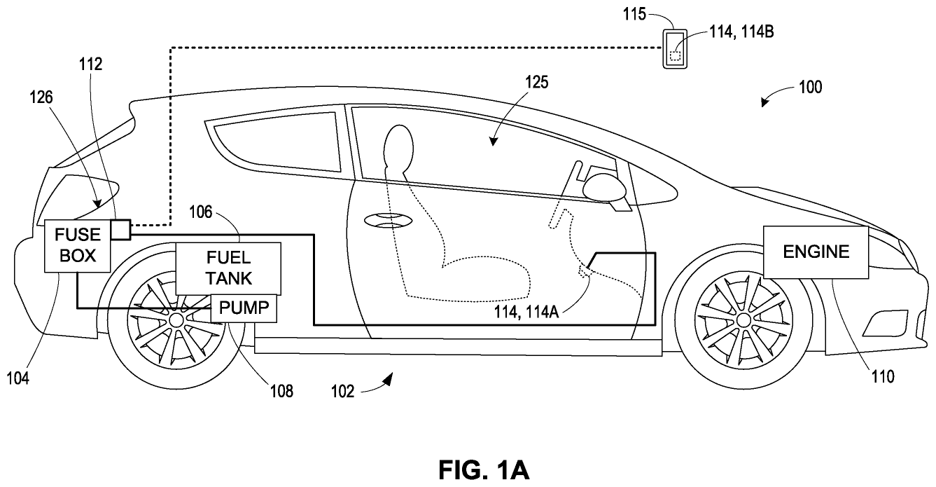

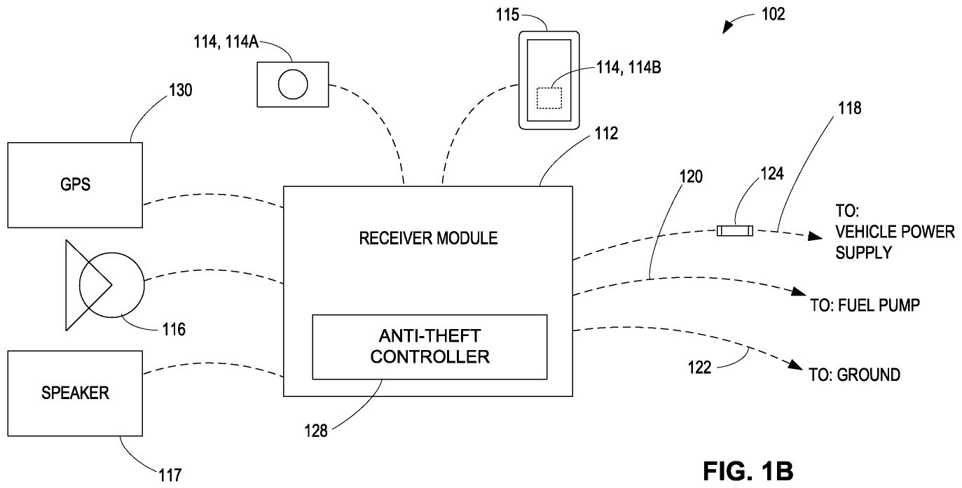

FIG. 1A is a side view of an example vehicle 100 including an example anti-theft system 102 implemented in accordance with teachings of this disclosure. FIG. 1B is a schematic diagram of the example anti-theft system 102 of FIG. 1A. In the illustrated example of FIG. 1A, the vehicle 100 includes an example fuse box 104, an example fuel tank 106, an example fuel pump 108, and an example engine 110. In the illustrated examples of FIGS. 1A and 1B, the anti-theft system 102 includes an example receiver module 112 and an example user interface 114. In the illustrated example of FIG. 1B, the anti-theft system 102 includes an example horn 116 (e.g., an air horn, a siren, a first audio generator), an example speaker (e.g., a second audio generator), an example first connection 118, an example second connection 120, and an example third connection 122. In the illustrated example of FIG. 1B, the first connection 118 includes an example fuse 124. As shown in FIG. 1B, the example receiver module 112 includes an example anti-theft controller 128.

In the illustrated example of FIG. 1A, the example vehicle 100 is a hatchback coupe. In other examples, the vehicle 100 can be any type of vehicle (e.g., a van, a pick-up truck, a sedan, a sports utility vehicle (SUV), a semi-trailer truck, a minivan, a railed vehicle, an all-terrain vehicle (ATV), etc.). In the illustrated example of FIG. 1A, the vehicle 100 is a two-axle vehicle. In other examples, the vehicle 100 can have additional axles and/or additional wheels. The example vehicle 100 can have a body-on-frame construction and/or a unibody construction. While the vehicle 100 is depicted as an automobile in the illustrated example of FIG. 1A, it should be appreciated that teachings of this disclosure are not limited thereto. For example, the vehicle 100 can include watercraft (e.g., jet skis, yachts, motorboats, etc.), construction equipment, farming equipment, etc.

In the illustrated example of FIGS. 1A and 1B, the engine 110 of the vehicle 100 is an internal combustion engine (ICE). That is, the engine 110 powers the powertrain of the vehicle 100 by combusting fuel (e.g., gasoline, diesel, etc.) stored in the fuel tank 106. During operation, the fuel pump 108 pumps fuel from the fuel tank 106 into a fuel line coupled to the engine 110. In other examples, the vehicle 100 is a partially electrified vehicle (e.g., a hybrid vehicle, etc.) and/or a fully electrified vehicle.

The anti-theft system 102 disables the vehicle 100 after the vehicle is stolen. For example, the anti-theft system 102 can disable operation of the vehicle 100 by cutting off power to the fuel pump 108, which prevents the flow of fuel from the fuel tank 106 to the engine 110. In some examples, the anti-theft system 102 has an “anti-carjacking mode,” which inhibits operation of the vehicle 100 after the vehicle 100 has been carjacked. Additionally or alternatively, the anti-theft system 102 can have an “anti-motor theft mode” that inhibits operation of the vehicle 100 after a motor theft of the vehicle 100.

The fuse box 104 is a grouping of fuses associated with the electrical components of the vehicle 100. As used herein, the fuse box 104 is also referred to as an “integrated power module.” In some examples, the fuse box 104 includes a fuse that is coupled to the fuel pump 108. In the illustrated example of FIG. 1, the fuse box 104 is disposed in an example trunk 126 of the vehicle 100. In other examples, the fuse box 104 is positioned in another portion of the vehicle 100 (e.g., depending on the make and model of the vehicle 100, etc.). For example, the fuse box 104 can be positioned under the hood of the vehicle 100, in an example passenger compartment 125 of the vehicle 100, etc. In some such examples, the receiver module 112 is positioned adjacent to the fuse box 104 in the corresponding portion of the vehicle 100. In other examples, the receiver module 112 is spaced from the fuse box 104 (e.g., in a different vehicle compartment, etc.) and some or all of the connections 118, 120, 122 extend between compartments of the vehicle 100 (e.g., from the passenger compartment 125 to the trunk 126, etc.).

The receiver module 112 is electrically coupled to the fuse box 104 and the user interface 114 (e.g., a wired coupling, a wireless coupling, etc.). In the illustrated example of FIG. 1B, the receiver module 112 is coupled to the fuse box 104 via the first connection 118 and the second connection 120. Particularly, the first connection 118 can be coupled to a starting, lighting, and ignition (SLI) battery and/or an alternator of the vehicle 100 and the second connection 120 can be coupled to the fuel pump 108. In some examples, the first connection 118 and the second connection 120 are implemented by a single connector. In some such examples, the connections 118, 120 replace the stock vehicle fuse associated with the fuel pump 108. In other examples, the connections 118, 120 are implemented by multiple connectors. In the illustrated example of FIG. 1B, the first connection 118 includes the fuse 124. The fuse 124 replaces the functionality of the stock fuse associated with the fuel pump 108. In some examples, the fuse 124 is absent. In some examples, the connections 118, 120 are coupled to the fuse associated with another system of the vehicle 100. For example, if the vehicle 100 is a fully electric vehicle, the connections 118, 120 can be coupled to the fuse associated with one or more electric motor(s) of the vehicle 100 or other components that are necessary to the operation of the vehicle 100 (e.g., other ignition components, etc.).

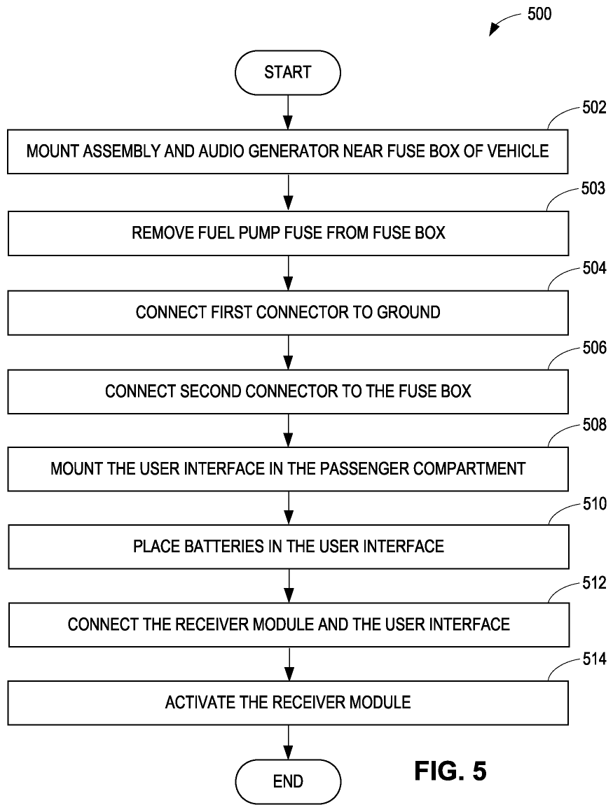

In the illustrated example of FIG. 1B, the third connection 122 grounds the receiver module 112. In some examples, the third connection 122 couples the receiver module 112 to a chassis and/or a body of the vehicle 100. In other examples, the third connection 122 is coupled to another portion of the vehicle 100. The connections 118, 120, 122 are described below in additional detail in conjunction with FIGS. 4A and 4B.

The user interface 114 enables an operator of the vehicle 100 to communicate with the receiver module 112. In some examples, the user interface 114 is implemented as a fixed user interface 114A and/or as a portable user interface 114B. As used herein, a “fixed user interface” means a user interface that is directly physically coupled to the vehicle 100 and remains attached to the vehicle 100 at all times when in use. By contrast, as used herein, a “portable user interface” means a user interface that is separable from the vehicle 100 and may be carried by an authorized user. Thus, a portable user interface can be used inside of, outside of, and/or (at least in some examples) remote from the vehicle 100. The user interface 114 shown in FIG. 1A is shown as a fixed user interface, but is intended to generally represent either a fixed user interface or a portable user interface. Both types of user interfaces 114A, 114B are represented in FIG. 1B for purposes of explanation. In some examples, the anti-theft system 102 includes both a fixed user interface 114A and a portable user interface 114B. In some examples, the anti-theft system 102 includes more than one fixed user interface 114A and/or more than one portable user interface 114B. In some examples, the anti-theft system includes only a fixed user interface 114A and omits the portable user interface 114B. In other examples, the anti-theft system includes only a portable user interface 114B and omits the fixed user interface 114A.

Whether fixed or portable, the user interface 114 can be implemented in any suitable manner. In the illustrated example of FIG. 1B, the fixed user interface 114A is a push-button switch. In other examples, the fixed user interface 114A can be implemented by a different type of switch (e.g., a toggle switch, a rocker switch, a rotary switch, a slide switch, etc.). In other examples, the fixed user interface 114A can be implemented by an audio interface (e.g., a microphone, etc.), a biometric switch (e.g., a fingerprint scanner, a retinal scanner, a palm scanner, a facial scanner, etc.), etc. In the illustrated example, the fixed user interface 114A is a distinct dedicated component coupled to the receiver module 112. In other examples, the fixed user interface 114A can be implemented by a stock switch of the vehicle 100 (e.g., a button on a steering wheel of the vehicle 100, a button on the console of the vehicle 100, a button on the dash of the vehicle 100, a button or icon on a touchscreen of the vehicle 100, etc.). In the illustrated examples of FIGS. 1A and 1B, the fixed user interface 114A is implemented by a single switch. In other examples, the fixed user interface 114A can be implemented by multiple switches (e.g., disposed at other locations in the passenger compartments, disposed at a same location in the passenger compartment, etc.).

In the illustrated example of FIG. 1B, the portable user interface 114B is implemented by a smartphone 115. More particularly, in some such examples, the portable user interface 114B is provided by a mobile application (app) installed on the smartphone. In other examples, any other type of mobile device (e.g., a tablet, a personal digital assistant, etc.) may be used. In some examples, the mobile app enables a user to arm and/or disarm the anti-theft system 102 by pressing a button or icon within a graphical user interface (GUI) of the mobile app (or toggling a widget associated with the mobile app). In some examples, the mobile app can be used to configure settings associated with the anti-theft system 102 (e.g., threshold times, alarm timing, the nature of the alarm (e.g., vibrations of the portable device, audible signal from the portable device, activating of the horn 116, activating of the speaker 117, etc.), enabling/disabling of certain behaviors, etc.). In some examples, the mobile app can monitor, track, record, and/or display the usage and/or status of aspects of the anti-theft system 102. For instance, in some examples, a GUI of the mobile app provides an indication of the state of the system (e.g., armed/disarmed) and/or a countdown timer to a change in status (e.g., countdown until warning, countdown until the fuel pump is disabled, etc.). In some examples, the mobile app maintains event logs that record alarm and/or disable events with associated timestamps. In some examples, the mobile app provides status/health indicators (e.g., power/battery status, tamper/power interruption events, etc.). In some examples, the mobile app can monitor and/or provide vehicle information and/or location information when available. In some examples, the mobile app can generate alerts and/or notifications in response to a relevant event occurring (e.g., an alarm/disable event, a tampering event, a power interruption event, etc.).

In some examples, the portable device is not directly connected to receiver module 112 (e.g., via BLUETOOTH®) and is instead connected via some intermediary component (e.g., an application programming interface (API), one or more cloud servers, etc.). In some such examples, the intermediary component monitors, tracks, and/or records events/states of the anti-theft system 102, and/or generates the associated notifications, alerts, and/or displays to be provided to a user. In some such examples, the event, logs, system states, notifications, alerts, displays, and the like can be provided to and/or accessed by any suitable device that can connect to the intermediary component regardless of whether the device includes the mobile app. For instance, in some examples where the information is stored by a cloud computer that hosts a website, the information can be accessed by any computing device with a web browser.

In the illustrated example of FIGS. 1A and 1B, the portable device, as a smartphone 115, is connected to a cellular network. In some such examples, the anti-theft system 102 uses the connection to the cellular network to contact the owner of the vehicle and/or law enforcement after a triggering event. In some examples, the mobile device can contact any other designated person (configurable by the user) via the cellular network after a suitable triggering event.

In some examples, the portable user interface 114B is any suitable type of one or more buttons or switches on an electronic fob. In some such examples, the electronic fob associated with the portable user interface 114B is a key fob associated with the vehicle 100. In other examples, the electronic fob is distinct from a key fob.

The user interface 114 is communicatively coupled to the receiver module 112. In the illustrated example of FIG. 1A, the user interface 114 (as a fixed user interface 114A) is connected to the receiver module 112 via a wired connection. In some such examples, the user interface 114 is connected to the receiver module 112 via a dedicated wired connection. In other examples, the user interface 114 is connected to the receiver module 112 via a connection associated with the vehicle 100 (e.g., a controller area network (CAN) bus of the vehicle 100, etc.). In other examples, such as the illustrated example of FIG. 1B, the user interface 114 is connected to the receiver module 112 via a wireless connection (as in the case of the portable user interface 114b and in some example implementations of the fixed user interface 114A). In some such examples, the user interface 114 communicates with the receiver module 112 via a radio frequency (RF) connection, a personal area network (PAN) connection, a BLUETOOTH® connection, a NEARLINK® connection, a near field communication (NFC) connection, an ultra-wideband (UWB) connection, a cellular network connection, etc.

The user interface 114 can be disposed in the example passenger compartment 125 of the vehicle 100 in an area that is hidden and/or accessible to an operator of the vehicle 100. In the illustrated example of FIG. 1A, the user interface 114 (as a fixed user interface 114A) is mounted under the dash of the vehicle 100. In other examples, the user interface 114 can be mounted at any other visibility-obstructed location of the vehicle 100 that is accessible to a driver of the vehicle (e.g., in the glove compartment, in the center console, under a seat of the vehicle, etc.). Additionally or alternatively, the user interface 114 can be placed in plain sight in the vehicle 100. In some such examples, the user interface 114 can be disguised as another feature associated with the vehicle (e.g., disguised as an air freshener, disguised as a phone mount, disguised as a tissue box, disguised as a stock button of the vehicle 100, etc.). In other examples, as discussed above, the user interface 114 (as a portable user interface 114B) can be implemented on a mobile device of a user of the vehicle 100 (e.g., an application on a smart device of the user, etc.), on the keys of the vehicle 100, and/or as a distinct device carried by a user of the vehicle 100 (e.g., a fob, etc.). In some such examples, the user interface 114 is an application programming interface (API) that is configured to facilitate communication between a mobile device and the receiver module 112.

In some examples, the horn 116 is an alarm that outputs audio (e.g., a loud noise, etc.) after the vehicle 100 is disabled by the anti-theft system 102. Additionally or alternatively, in some examples, the horn 116 is an alarm that outputs audio (e.g., a blast from a horn, a recorded message provided by a speaker, etc.) as a warning to a user of the vehicle 100 before the vehicle 100 is disabled by the anti-theft system 102. In some examples, the audio (e.g., a horn blast) produced by the horn 116 can alert law enforcement to the location of the vehicle 100.

In the illustrated example of FIG. 1B, the horn 116 is a distinct device electrically coupled to the receiver module 112. In some such examples, the horn 116 is disposed in a same housing as the receiver module 112. In other examples, the horn 116 is a distinct device that is coupled to the receiver module 112 (e.g., via a wired connection, via a wireless connection, etc.). In some examples, the anti-theft system 102 includes more than one horn 116. Additionally or alternatively, in some examples, the horn 116 is the stock horn and/or a stock alarm system of the vehicle 100. In some such examples, the receiver module 112 is electrically coupled to the stock vehicle horn. In other examples, the horn 116 is absent.

Additionally or alternatively, the anti-theft system 102 can include additional systems to alert law enforcement and/or the owner of the vehicle 100. For example, the receiver module 112 can include a cellular interface to contact law enforcement and/or a driver after the vehicle 100 is disabled by the anti-theft system 102. In some examples, such functionality is provided by a mobile phone that also provides the user interface 114 (as a portable user interface 114B). In some examples, the anti-theft system 102 can include a visual interface (e.g., a flasher light, a strobe light, etc.) that activates after the vehicle 100 is disabled.

In some examples, the speaker 117 is an alarm that outputs audio (e.g., a loud noise, etc.) after the vehicle 100 is disabled by the anti-theft system 102. Additionally or alternatively, in some examples, the speaker 117 is an alarm that outputs audio (e.g., a recorded message, etc.) as a warning to a user of the vehicle 100 that indicates the vehicle 100 is about to be disabled by the anti-theft system 102. In some such examples, the audio output by the speaker 117 includes an audible countdown timer (e.g., time remaining until the vehicle 100 is disabled). The speaker 117 can additionally or alternatively be used for other purposes besides functioning as an alarm. For instance, in some examples, the audio produced by the speaker 117 can announce to the driver the current mode and/or state of the anti-theft system 102 (e.g., a voice recording can be played to specify whether the system is armed, disarmed, authorized, etc.). In some examples, the speaker 117 is associated with a sound generator and/or voice module to generate the spoken audio. In some examples, the speaker 117 produces a confirmation chime in response to any other suitable trigger (e.g., when a button is pressed, when a command is received, when phone authorization is detected, etc.).

In some examples, the horn 116 and the speaker 117 are implemented by the same component. In the illustrated example of FIG. 1B, the speaker 117 is a distinct device electrically coupled to the receiver module 112. In some such examples, the speaker 117 is disposed in a same housing as the receiver module 112. In other examples, the speaker 117 is a distinct device that is coupled to the receiver module 112 (e.g., via a wired connection, via a wireless connection (e.g., BLUETOOTH®), etc.). In some such examples, the speaker 117 is part of an announcer unit that plugs into the On-Board Diagnostic II (OBD2) port of the vehicle 100. In some examples, the anti-theft system 102 includes more than one speaker 117. Additionally or alternatively, in some examples, the speaker 117 is the stock speaker(s) and/or audio system of the vehicle 100. In some such examples, the receiver module 112 is electrically coupled to the stock speaker(s). In some examples, speaker(s) on the portable device that implement the user interface 114 serve as the speaker 117. In some examples, the speaker 117 is absent.

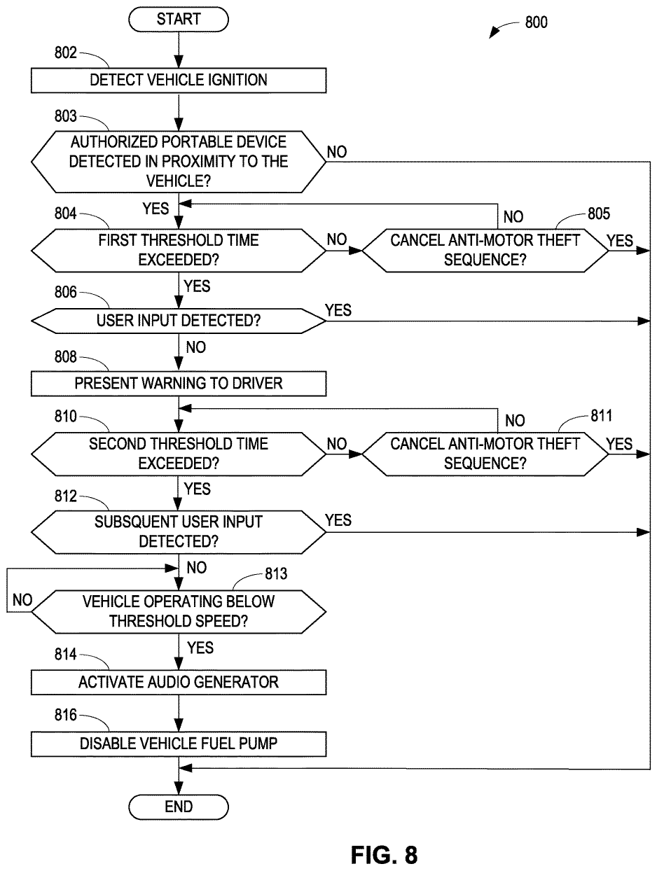

The anti-theft controller 128 disables the vehicle 100 after the vehicle 100 is stolen. In some examples, the anti-theft controller 128 includes anti-carjacking functionality. In some such examples, when the anti-theft controller 128 detects an input to the user interface 114 while the vehicle 100 is in operation (e.g., the vehicle 100 is undergoing a carjacking and the driver presses the button, etc.), the anti-theft controller 128 can cut off power to the fuel pump 108 after a threshold time, which prevents operation of the vehicle 100. In some such examples, the threshold time enables the thief to drive a short distance from the original driver (e.g., authorized user) of the vehicle 100, which reduces the likelihood of retaliation from the thief to the original user and enables the original user to contact law enforcement. In some examples, the anti-theft controller 128 can activate the horn 116 and/or the speaker 117 before disabling the vehicle 100 to alert law enforcement to the location of the vehicle 100. In other examples, the anti-theft controller 128 activates the horn 116 and/or the speaker 117 before or while disabling the vehicle 100. Operations associated with the anti-carjacking mode are described below in conjunction with FIG. 7.

Additionally or alternatively, the anti-theft controller 128 includes anti-motor theft functionality, which inhibits theft of the vehicle 100 while it is parked and off. For example, the anti-theft controller 128 can detect the ignition of the vehicle 100 by detecting the flow of electricity via the connections 118, 120 from a power supply of the vehicle 100 to the fuel pump 108. In some examples, after detecting the ignition of the vehicle 100, the anti-theft controller 128 can cut off power to the fuel pump 108 after a threshold time, which disables operation of the vehicle 100. Operations associated with the anti-motor theft mode are described below in conjunction with FIG. 8.

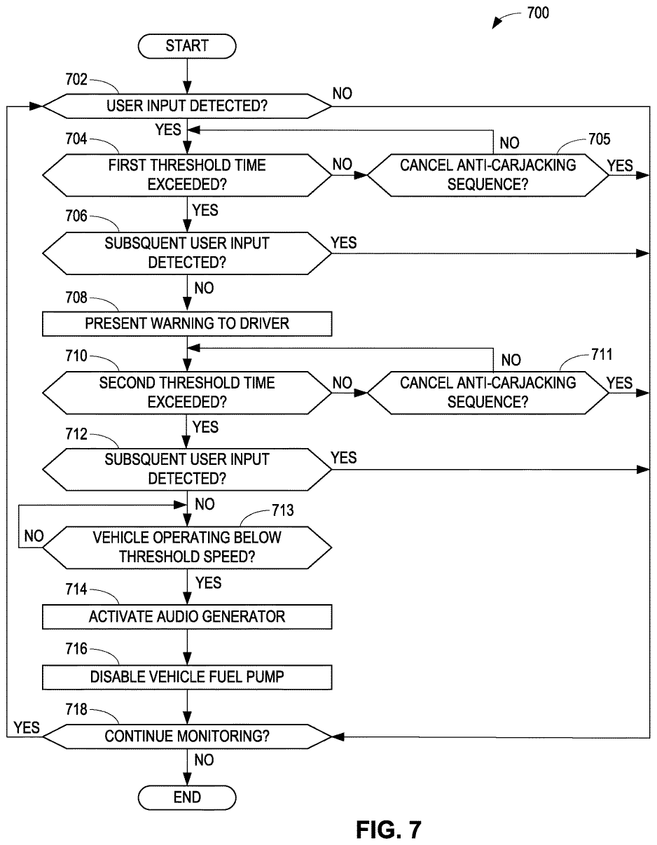

In some examples, the anti-theft controller 128 does not disable the fuel pump 108 if a user input is detected after the anti-theft controller 128 has detected an original user input (e.g., the anti-theft controller 128 is operating in an anti-carjacking mode, etc.) and/or the anti-theft controller 128 has detected ignition of the vehicle 100 (e.g., the anti-theft controller 128 is operating in an anti-motor theft mode, etc.). To prevent the unintended disabling of a vehicle while operated by an authorized user, the anti-theft controller 128 can provide a warning to a user (e.g., via the horn 116, the speaker 117, a display screen in the vehicle 100, display screen, and/or lights associated with a portable user interface 114B, etc.) to remind the user to activate the user interface 114 prior to disabling the vehicle 100 (e.g., only an authorized user of the vehicle 100 would know the location of the user interface 114, etc.). In some examples, the anti-theft controller 128 can activate the horn 116 and/or the speaker 117 before disabling the vehicle 100 to alert the owner of the vehicle 100 and/or law enforcement to the location of the vehicle 100. In some examples, the anti-theft controller 128 is configured to only recognize user inputs that satisfy one or more predetermined criteria (e.g., pressing a button of the user interface 114 for a predetermined duration, inputting a predetermined code into the user interface 114, a particular biometric input, exposure to a particular radio frequency identification (RFID) tag, etc.) to prevent accidental activation of the anti-theft controller 128 and/or to prevent an authorized user from deactivating the anti-theft system 102. In some examples, a user of the anti-theft system 102 is provided an RFID tag for operating the user interface 114. In some such examples, the RFID tag can be associated with a fob, adhered to the exterior of a mobile device of the user, carried in a wallet of the user, etc. The anti-theft controller 128 is described below in additional detail in conjunction with FIG. 6.

Additionally or alternatively, in some examples, when the anti-theft system 102 includes a portable user interface 114B (e.g., implemented on a portable device carried by an authorized user), detection of the presence and/or proximity of the portable device automatically disarms the anti-theft system 102. That is, in some examples, when a portable device of an authorized user is detected in proximity to the vehicle 100 (e.g., based on a valid pairing with the receiver module 112), the anti-theft controller 128 does not disable the fuel pump 108 or provide a warning to the user that such is about to occur. In other words, in some such examples, users carrying a portable user interface 114B do not need to press any button or toggle the user interface 114 each time they return to their vehicles. In some examples, a portable device that does not implement a portable user interface 114B can still be used to disarm the anti-theft system 102 when detected in proximity to the vehicle 100. In some examples, multiple different portable devices can serve this purpose. In some examples, such portable devices can be added to a whitelist of authorized portable devices that is stored by the receiver module 112. In some examples, mechanisms are provided to report lost and/or stolen portable devices so they can be removed from the authorized list of devices. In some such examples, a lost or stolen device can be reported through a separate portable device paired to the system. Additionally or alternatively, in some examples, a lost or stolen device can be reported through a website that can connect to the receiver module 112 over the Internet and/or other suitable network.

In the illustrated example of FIG. 1B, the anti-theft system 102 includes an example global positioning system (GPS) 130. The GPS 130 is a satellite-based radio navigation system that can provide position, velocity, and/or acceleration data to the anti-theft controller 128. In some examples, the anti-theft controller 128 accesses the output of the GPS 130 to determine the operational condition of the vehicle 100. For example, the anti-theft controller 128 accesses the output of the GPS 130 to determine if the vehicle 100 is below a threshold speed (e.g., the vehicle 100 is at rest, the vehicle 100 has a velocity of less than 5 miles per hour (mph), the vehicle 100 has a velocity of less than 15 mph, the vehicle 100 has a velocity of less than 40 mph, etc.). In some such examples, the anti-theft controller 128 only disables the vehicle 100 if the anti-theft controller 128 determines the vehicle 100 is traveling beneath the threshold speed.

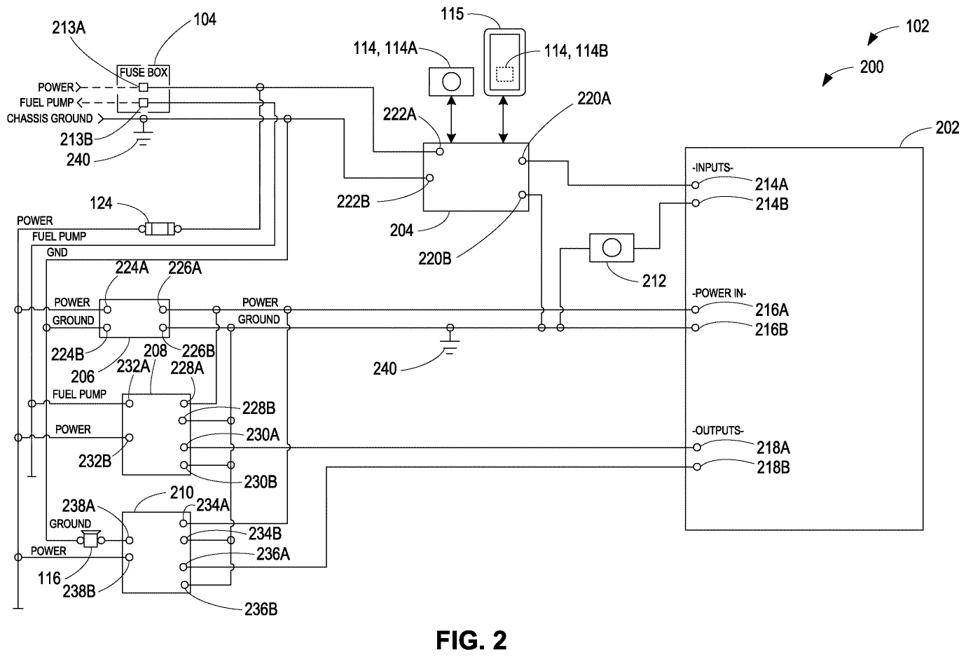

FIG. 2 is an example electrical schematic diagram 200 of the anti-theft system 102 of FIGS. 1A and 1B. In the illustrated example of FIG. 2, the anti-theft system 102 is electrically coupled to the fuse box 104 of FIG. 1A. In the illustrated example of FIG. 2, the anti-theft system 102 includes the user interface 114 of FIGS. 1A and 1B, the horn 116 of FIG. 1B, and the fuse 124 of FIG. 1B. In the illustrated example of FIG. 2, the anti-theft system 102 includes an example microcontroller 202, an example receiver 204, an example voltage regulator 206, an example first relay 208, an example second relay 210, and an example second user interface 212. In the illustrated example of FIG. 2, the receiver 204 and the voltage regulator 206 are coupled to the fuse box 104. In the illustrated example of FIG. 2, the fuse box 104 includes an example fuel pump power input terminal 213A and an example fuel pump power output terminal 213B.

The microcontroller 202 receives input from the receiver 204 and communicates with the relays 208, 210 to disable the fuel pump 108 of FIG. 1A and activate the horn 116, respectively. In the illustrated example of FIG. 2, the microcontroller 202 includes an example first microcontroller input terminal 214A, an example second microcontroller input terminal 214B, an example first microcontroller power input terminal 216A, an example second microcontroller power input terminal 216B, an example first microcontroller output terminal 218A, and an example second microcontroller output terminal 218B.

The receiver 204 communicatively couples the user interface 114 to the microcontroller 202. In the illustrated example of FIG. 2, the receiver 204 includes an example first receiver output terminal 220A, an example second receiver output terminal 220B, an example first receiver power terminal 222A, and an example second receiver power terminal 222B. The voltage regulator 206 lowers and/or smooths the power flowing from the fuse box 104 to the microcontroller 202. In the illustrated example of FIG. 2, the voltage regulator 206 includes an example first voltage regulator input terminal 224A, an example second voltage regulator input terminal 224B, an example first voltage regulator output terminal 226A, and an example second voltage regulator output terminal 226B.

The first relay 208 is a switch that couples the microcontroller 202 to the fuel pump power output terminal 213B. The first relay 208 enables the microcontroller 202 to control the flow of power between the fuel pump power input terminal 213A and the fuel pump power output terminal 213B (e.g., operation of the fuel pump 108 of FIG. 1A, etc.). In the illustrated example of FIG. 2, the first relay 208 includes an example first relay power input terminal 228A, an example second relay power input terminal 228B, an example first relay input terminal 230A, an example second relay input terminal 230B, an example first relay output terminal 232A, and an example third relay input terminal 232B.

The second relay 210 is a switch that couples the microcontroller 202 to the horn 116 and enables the microcontroller 202 to control the operation thereof. Additionally or alternatively, in some examples, the second relay 210 (and/or a third relay not shown) is a switch that coupled the microcontroller 202 to the speaker 117 to control operation thereof. In the illustrated example of FIG. 2, the second relay 210 includes an example third relay power input terminal 234A, an example fourth relay power input terminal 234B, an example fourth relay input terminal 236A, an example fifth relay input terminal 236B, an example second relay output terminal 238A, and an example sixth relay input terminal 238B. In the illustrated example of FIG. 2, the electrical schematic diagram 200 includes an example ground 240. In some examples, the ground 240 is the frame and/or body of the vehicle 100.

In the illustrated example of FIG. 2, the receiver 204 is a wireless receiver that communicatively couples the microcontroller 202 to the user interface 114. In the illustrated example of FIG. 2, the microcontroller 202 is coupled to the receiver 204 via the first microcontroller input terminal 214A. In some examples, the receiver 204 outputs a binary indication via the first receiver output terminal 220A that is indicative of the position of the user interface 114. In some examples, the first receiver output terminal 220A is a normally open terminal. In other examples, the first receiver output terminal 220A is a normally closed terminal. In the illustrated example of FIG. 2, the second receiver output terminal 220B and the second receiver power terminal 222B are coupled to ground.

In the illustrated example of FIG. 2, the receiver 204 is powered via a connection to the fuse box 104 at the first receiver power terminal 222A. In other examples, the first receiver power terminal 222A is coupled to the voltage regulator 206 (e.g., the receiver 204 is powered at the same voltage as the microcontroller 202, etc.). During operation, the microcontroller 202 receives inputs from the first receiver output terminal 220A indicative of when the user interface 114 has received a user input (e.g., a user of the anti-theft system 102 has activated the anti-theft system 102, etc.). In some examples, the receiver 204 is absent. In some such examples, the user interface 114 is coupled directly to the first microcontroller input terminal 214A (e.g., via a wired connection, etc.). In some examples, the microcontroller 202 and/or the receiver 204 implement some or all of the anti-theft controller 128 of FIG. 1B.

In the illustrated example of FIG. 2, the second microcontroller input terminal 214B of the microcontroller 202 is coupled to the second user interface 212. In some examples, the second user interface 212 is a physical switch that is directly coupled to the microcontroller 202 (e.g., physically coupled to the receiver module 112 of FIGS. 1A and 1B, etc.). In some examples, the second user interface 212 enables control of the anti-theft system 102 if the user interface 114 is inoperable (e.g., the user interface 114 becomes uncoupled from the receiver 204, the user interface 114 runs out of battery, etc.). In some such examples, the second microcontroller input terminal 214B provides the same functionality as the user interface 114 (e.g., the microcontroller 202 treats inputs from the first microcontroller input terminal 214A and the second microcontroller input terminal 214B the same, etc.). Additionally or alternatively, the second user interface 212 can be used to set the threshold time between the microcontroller 202 receiving an input at the first microcontroller input terminal 214A and sending an output to the first relay 208 and/or the second relay 210 (e.g., the threshold time between a user activating the user interface 114 and the vehicle 100 being disabled, the threshold time between ignition of the vehicle 100 and the vehicle 100 being disabled, etc.).

The voltage regulator 206 provides power to the microcontroller 202. In some examples, the voltage regulator 206 lowers the voltage of the power flowing from the fuse box 104 into the first voltage regulator input terminal 224A and out of the voltage regulator output terminal 226A (e.g., from twelve volts to five volts, etc.). In some examples, the voltage regulator 206 can smooth and/or otherwise modify the power leaving the voltage regulator output terminal 226A. In the illustrated example of FIG. 2, the second voltage regulator input terminal 224B and the second voltage regulator output terminal 226B are coupled to the ground 240. In the illustrated example of FIG. 2, the voltage regulator output terminal 226A is coupled to the first microcontroller power input terminal 216A. In some implementations, the voltage regulator 206 could be omitted, provided the microcontroller 202 is operable at the voltage provided by the fuse box 104.

The first relay 208 is a switch that couples the microcontroller 202 to the fuel pump power input terminal 213A. In the illustrated example of FIG. 2, the first microcontroller output terminal 218A of the microcontroller 202 is coupled to the first relay input terminal 230A. In the illustrated example of FIG. 2, the first relay output terminal 232A of the first relay 208 is electrically coupled to the fuel pump power output terminal 213B of the fuse box 104. In the illustrated example of FIG. 2, the third relay input terminal 232B of the first relay 208 is electrically coupled to the fuel pump power input terminal 213A of the fuse box 104. In the illustrated example of FIG. 2, the first relay 208 is powered via a connection to the voltage regulator 206 at the first relay power input terminal 228A. In the illustrated example of FIG. 2, the second relay power input terminal 228B and the second relay input terminal 230B are coupled to the ground 240.

In some examples, the first relay 208 is in a normally closed position. That is, the first relay output terminal 232A and the third relay input terminal 232B are electrically connected during normal operation of the anti-theft system 102. In some examples, receiving an input from the first microcontroller output terminal 218A via the first relay input terminal 230A causes the first relay 208 to open, which causes the first relay output terminal 232A and the third relay input terminal 232B to become electrically uncoupled. The uncoupling of the first relay output terminal 232A and the third relay input terminal 232B causes power to stop flowing from the fuel pump power input terminal 213A to the fuel pump power output terminal 213B, which disables the fuel pump 108 of FIG. 1A and the vehicle 100. In some examples, the first relay 208 is an octocoupler relay. That is, the first relay 208 electrically isolates the microcontroller 202 from the fuel pump power input terminal 213A. In other examples, the first relay 208 can be implemented by any other suitable type of relay.

The second relay 210 is a switch that couples the microcontroller 202 to the horn 116 (and/or the speaker 117). In the illustrated example of FIG. 2, the second microcontroller output terminal 218B of the microcontroller 202 is coupled to the fourth relay input terminal 236A. In the illustrated example of FIG. 2, the second relay output terminal 238A of the second relay 210 is electrically coupled to the horn 116 (and/or the speaker 117). In the illustrated example of FIG. 2, the sixth relay input terminal 238B of the second relay 210 is electrically coupled to the fuel pump power input terminal 213A of the fuse box 104. In the illustrated example of FIG. 2, the second relay 210 is powered via a connection to the voltage regulator 206 at the third relay power input terminal 234A. In the illustrated example of FIG. 2, the fourth relay power input terminal 234B and the fifth relay input terminal 236B are coupled to the ground 240.

In some examples, the second relay 210 is in a normally open position. That is, the second relay output terminal 238A and the sixth relay input terminal 238B are not electrically connected during normal operation of the anti-theft system 102. In some examples, receiving an input from the second microcontroller output terminal 218B via the fourth relay input terminal 236A causes the second relay 210 to close, which causes the second relay output terminal 238A and the sixth relay input terminal 238B to become electrically connected. The coupling of the second relay output terminal 238A and the sixth relay input terminal 238B causes the horn 116 (and/or the speaker 117) to produce a noise. In some examples, the second relay 210 is an octocoupler relay. That is, the second relay 210 electrically isolates the microcontroller 202 from the fuel pump power input terminal 213A. In other examples, the second relay 210 can be implemented by any other suitable type of relay.

During operation, the microcontroller 202 monitors for inputs to the microcontroller input terminals 214A, 214B (e.g., monitors for a user input to the user interfaces 114, 212, etc.). In some examples, if the anti-theft system 102 is operating in an anti-carjacking mode, the microcontroller 202 can start a timer after receiving an input via one of the microcontroller input terminals 214A, 214B. In some examples, if the anti-theft system 102 is operating in an anti-motor theft mode, the microcontroller 202 can start a timer after detecting the ignition of the vehicle 100 (e.g., the vehicle 100 has started, etc.). In some examples, the microcontroller 202 detects ignition of the vehicle 100 when the microcontroller 202 receives power via the first microcontroller power input terminal 216A. That is, the microcontroller 202 determines the vehicle 100 has undergone ignition based on whether the microcontroller 202 is powered. In other examples, the microcontroller 202 can determine whether the vehicle 100 has undergone ignition in any other suitable manner (e.g., via a sensor coupled to the fuel pump 108, via a sensor in the engine compartment, etc.).

After starting a timer, the microcontroller 202 awaits further input from the user interfaces 114, 212. In some examples, if the microcontroller 202 receives a subsequent input from the microcontroller input terminals 214A, 214B (e.g., the user has input another command into the user interfaces 114, 212, etc.), the microcontroller 202 stops the timer and takes no further action. In some examples, if the microcontroller 202 does not receive a subsequent input from the microcontroller input terminals 214A, 214B (e.g., the user has not input another command into the user interfaces 114, 212, etc.) within a first threshold time since the timer started, the microcontroller 202 outputs a signal to the relays 208, 210 via the microcontroller output terminals 218A, 218B, which stops power to the fuel pump power output terminal 213B and activates the horn 116. In some such examples, if the microcontroller 202 does not receive a subsequent input from the microcontroller input terminals 214A, 214B (e.g., the user has not input another command into the user interfaces 114, 212, etc.) within a second threshold time since the timer started, where the second threshold time is reached before the first threshold time, the microcontroller 202 outputs a signal to the second relay 210 via the second microcontroller output terminal 218B, which activates the horn 116 (and/or the speaker 117) to warn a user to input a command to the user interface 114.

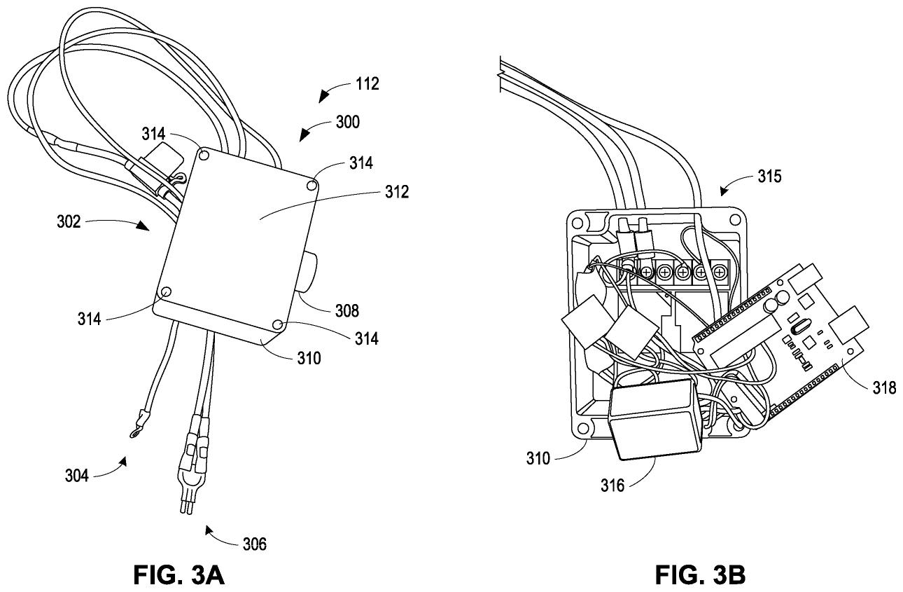

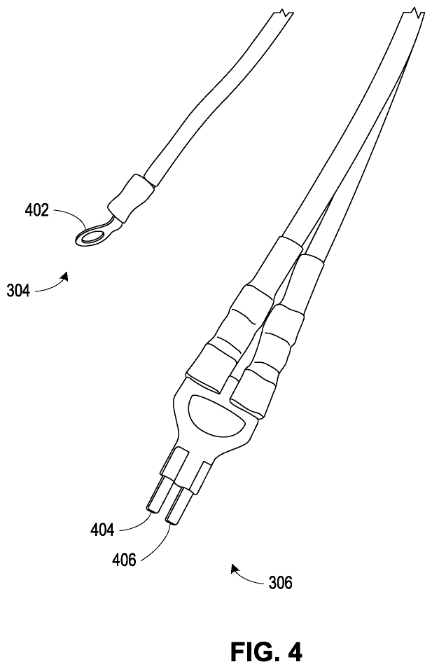

FIG. 3A is a perspective view of an example assembly 300 that can implement the receiver module 112 of FIGS. 1A-2. In the illustrated example of FIG. 3A, the assembly 300 includes an example housing 302, an example first connector 304, an example second connector 306, and an example audio generator 308. During installation of the anti-theft system 102, the assembly 300 can be coupled to a vehicle (e.g., the vehicle 100, etc.) adjacent to a fuse box of the vehicle (e.g., the fuse box 104, etc.). For example, the assembly 300 can be disposed in the trunk 126 of a vehicle, in the passenger compartment 125 of the vehicle, and/or in the engine compartment of the vehicle. In some such examples, the assembly 300 can be coupled to the vehicle 100 via one or more fasteners (e.g., via one or more screws, via one or more bolts, via hook-and-loop fasteners, via one or more zip ties, etc.), via one or more interference fits, via one or more chemical adhesives, etc.

The housing 302 contains, supports, and/or protects the electrical components of the assembly 300. In the illustrated example of FIG. 3A, the housing 302 includes an example body 310 and an example faceplate 312. In some examples, the body 310 and/or the faceplate 312 can be composed of a same material (e.g., a metal, a plastic, a composite, a natural material, etc.). In other examples, the body 310 and/or the faceplate 312 can be composed of one or more different materials. In the illustrated example of FIG. 3A, the faceplate 312 is coupled to the body 310 via a plurality of fasteners 314. In some examples, the fasteners 314 are absent. In some such examples, the faceplate 312 can be coupled to the body 310 via one or more interference fits, via one or more chemical adhesives, via one or more hinges, etc. In other examples, the assembly 300 does not include the faceplate 312. The interior of the housing 302 is disclosed below in conjunction with FIG. 3B.

The audio generator 308 can implement the audio generator 116 and/or the speaker 117 of FIGS. 1B and 2. In the illustrated example of FIG. 3A, the audio generator 308 extends from the exterior of the housing 302. In other examples, the audio generator 308 is a distinct device coupled to the assembly 300 (e.g., coupled via a wire, wireless coupled, etc.). In some examples, the audio generator 308 is absent. In some such examples, the assembly 300 can be electrically coupled to an alarm system and/or the audio generator of the vehicle (e.g., the vehicle 100, etc.). The connectors 304, 306 can implement some or all of the connections 118, 120, 122 of FIG. 1B. In the illustrated example of FIG. 3A, the connectors 304, 306 extend from the body 310 of the housing 302. The connectors 304, 306 are disclosed below in additional detail in conjunction with FIG. 4.

FIG. 3B is a perspective view of an example interior 315 of the housing 302 of the assembly 300 of FIG. 3A. In the illustrated example of FIG. 3B, the faceplate 312 of FIG. 3A has been removed from the body 310 (e.g., the fasteners 314 of FIG. 3A have been removed, etc.) to reveal the interior 315. In the illustrated example of FIG. 3B, the interior 315 of the assembly 300 includes an example wireless receiver 316 and an example integrated circuit 318. In some examples, the integrated circuit 318 can implement the microcontroller 202 of FIG. 2, the first relay 208 of FIG. 2, and/or the second relay 210 of FIG. 2. In some examples, some or all of the circuitry of the electrical schematic diagram 200 of FIG. 2 can be mounted on and/or implemented by the integrated circuit 318. That is, the integrated circuit 318 can include circuitry that disables a fuel pump of a vehicle (e.g., via the connector 306 of FIG. 3A, etc.) and/or activate the audio generator 308 of FIG. 3. In some examples, the wireless receiver 316 can implement the receiver 204 of FIG. 2. That is, the wireless receiver 316 can be wirelessly coupled to a user interface disposed in the passenger compartment 125 of a vehicle (e.g., the fixed user interface 114A of FIGS. 1A and 1B, etc.) and/or carried by a user (e.g., the portable user interface 114B of FIGS. 1A and 1B, etc.). In some examples, the interior 315 includes the GPS 130 of FIG. 1B. In some such examples, an antenna of the GPS 130 can extend from the exterior of the housing 302.

FIG. 4 is a perspective detail view of the connectors 304, 306 of the assembly 300 of FIGS. 3A and 3B. In the illustrated example of FIG. 4, the first connector 304 includes an example coupling 402. In some examples, the first connector 304 can implement the third connection 122 of FIG. 1B. That is, the first connector 304 can be coupled to ground. In some such examples, the coupling 402 can be connected to the chassis of a vehicle including the assembly 300. In other examples, the first connector 304 can be coupled to any other suitable structure (e.g., another terminal in the fuse box 104, etc.).

In the illustrated example of FIG. 4, the second connector 306 includes an example first prong 404 and an example second prong 406. In some examples, the first prong 404 and the second prong 406 can implement the first connection 118 of FIG. 1B and the second connection 120 of FIG. 1B, respectively. In some such examples, the first prong 404 is to be electrically coupled to a power supply of a vehicle 100 (e.g., the SLI battery of a vehicle, etc.) and the second prong 406 is to be electrically coupled to a fuel pump of a vehicle (e.g., the fuel pump 108 of FIG. 1A, etc.). In some examples, the second connector 306 replaces the stock fuse associated with a fuel pump of a vehicle. In some such examples, during installation of the assembly 300, the stock fuse associated with the fuel pump is removed and replaced with the second connector 306. In some examples, the spatial relationship of the prongs 404, 406 on the second connector 306 is adjustable to enable the second connector 306 to replace fuses of different sizes. Additionally or alternative, the ends of the second connector 306 can be interchangeable with ends of different sizes to accommodate vehicle fuses of different sizes (e.g., the second connector 306 can have four different sizes to accommodate the four distinct sizes of vehicle fuses, etc.). In other examples, the prongs 404, 406 can be implemented by distinct connectors.

In some examples, the second connector 306 can include indicia (e.g., a sticker, a molded extrusion, a molded inclusion, etc.) indicating the correct orientation of the second connector 306. For example, the second connector 306 can include indicia indicating the first prong 404 should be coupled to the fuel pump power input terminal 213A of FIG. 2 and the second prong 406 should be coupled to the fuel pump power output terminal 213B of FIG. 2. In some examples, if the second connector 306 is incorrectly installed (e.g., the second prong 406 is coupled to the fuel pump power input terminal 213A and the first prong 404 is coupled to the fuel pump power output terminal 213B, etc.), the fuel pump of the vehicle 100 will not receive power and the vehicle including the assembly 300 will be inoperable until the installation of the second connector 306 is corrected.

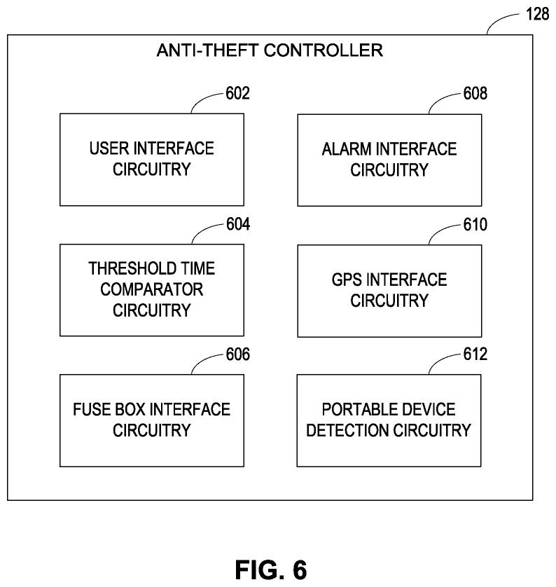

FIG. 5 is a flow diagram of example operations 500 that can be used to install the anti-theft system 102 of FIGS. 1A and 1B to a vehicle. The example operations 500 are described with reference to the assembly 300 of FIGS. 3A-4 and the vehicle 100 of FIG. 1. It should be appreciated by those having ordinary skill in the art that the operations 500 can be used to mount the assembly 300 to any other suitable type of vehicle. Similarly, it should be appreciated by those having ordinary skill in the art that the receiver module 112 can have a different form factor than the assembly 300 of FIGS. 3A-4 (e.g., the receiver module 112 can be implemented by multiple assemblies, the receiver module 112 can include a different configuration of circuitry, etc.). It should also be appreciated by those having ordinary skill in the art that the operations associated with mounting of the assembly 300 to the vehicle 100 can each or all be performed by one or more different entities, operators, and/or machines at one or more different locations.

The operations 500 begin at block 502. At block 502, the assembly 300 and audio generator 308 are mounted near the fuse box 104 of the vehicle 100. For example, if the fuse box 104 is disposed in the trunk 126 of the vehicle 100, the assembly 300 can be mounted within the trunk 126 of the vehicle 100. In other examples, the assembly 300 can be mounted in any other location of the vehicle 100 (e.g., depending on the location of the fuse box 104, etc.). In some examples, the assembly 300 is mounted to the vehicle 100 via one or more fasteners (e.g., via one or more screws, via one or more zip-ties, via hook-and-loop fasteners, etc.). In other examples, the assembly 300 can be mounted to the vehicle 100 via one or more interference fits, via one or more chemical adhesives, via one or more welds, etc. In some examples, the audio generator 308 is physically coupled to the assembly 300. In other examples, the audio generator 308 is separately mounted near the fuse box 104 of the vehicle 100. At block 503, the fuel pump fuse is removed from the fuse box 104. For example, the fuse disposed between the power supply of the vehicle 100 and the fuel pump 108 can be manually removed by an operator installing the anti-theft system 102. In other examples, the fuel pump fuse is not removed. In some examples, a connection to the assembly 300 is spliced into the fuse pump wired connection of the fuse box 104 (e.g., the wire connecting the fuse box 104 to the fuel pump 108 is cut and a connection to the assembly 300 is spliced therebetween, etc.).

At block 504, the first connector 304 of FIGS. 3A and 4 is coupled to ground. For example, the first connector 304 can be coupled to the chassis, frame, and/or body of the vehicle 100. At block 506, the second connector 306 is coupled to the fuse box 104. For example, the second connector 306 can be coupled in the fuse box 104 in the location associated with the fuse removed during the execution of block 503. In some such examples, the second connector 306 is coupled to the fuse box 104 such that the first prong 404 is electrically coupled to a power supply of a vehicle 100 (e.g., the fuel pump power input terminal 213A of FIG. 2, etc.) and the second prong 406 is electrically coupled to the fuel pump 108 of a vehicle (e.g., the fuel pump power output terminal 213B of FIG. 2, etc.). In some examples, the second connector 306 can be manually adjusted to properly fit the size of the port of the fuse box 104.

At block 508, the user interface 114 is mounted in the passenger compartment 125. For example, the user interface 114 can be mounted in the passenger compartment in an area that is accessible to an operator of the vehicle 100 (e.g., a driver of the vehicle 100, etc.) and/or hidden from plain view of the vehicle. For example, the user interface 114 can be mounted under the dashboard of the vehicle 100, in the glove compartment of the vehicle 100, in the center console of a vehicle 100, etc. In some examples, the execution of block 508 is excluded. In some such examples, the user interface 114 can be implemented by a mobile device of a user of the vehicle 100 and/or on the keys of the vehicle 100 (e.g., implemented as the portable user interface 114B). At block 510, batteries are placed in the user interface 114. In some examples, the execution of block 510 is omitted because batteries are not needed. In some such examples, the user interface 114 can be powered via the connection to the user module established during the execution of block 512. In other examples, the user interface 114 can be coupled to a power system of the vehicle 100 (e.g., coupled to a power outlet in the passenger compartment 125 the vehicle 100, etc.)

At block 512, the receiver module 112 and the user interface 114 are connected. For example, the receiver module 112 and the user interface 114 can be wirelessly connected via one or more wireless communication protocols, etc. Additionally or alternatively, the receiver module 112 and the user interface 114 can be connected via one or more wires. In some examples, dedicated wiring can be installed in the vehicle 100 to couple the receiver module 112 and the user interface 114 (e.g., wiring extending through the passenger compartment 125, etc.). In other examples, the receiver module 112 and the user interface 114 can be coupled via the communication system of the vehicle 100 (e.g., connected via the CAN bus of the vehicle 100, etc.). At block 514, the receiver module 112 is activated. For example, a switch on the housing 302 can be turned on. In other examples, the receiver module 112 is automatically activated when the vehicle 100 is started (e.g., via the connection to the fuse box 104, etc.). Thereafter, the operations 500 end.

Although the example method of installation is described with reference to the flowchart illustrated in FIG. 5, many other methods may alternatively be used. For example, the order of execution of the blocks may be changed, and/or some of the blocks described may be combined, divided, re-arranged, omitted, eliminated, and/or implemented in any other way.

FIG. 6 is a block diagram of an example implementation of the anti-theft controller 128 of FIG. 1B to control the anti-theft system 102 of FIGS. 1A and 1B. In the illustrated example of FIG. 6, the anti-theft system 102 includes example user interface circuitry 602, example threshold time comparator circuitry 604, example fuse box interface circuitry 606, example alarm interface circuitry 608, example GPS interface circuitry 610, and example portable device detection circuitry 612.

The anti-theft controller 128 of FIG. 6 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the anti-theft controller 128 of FIG. 6 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers.

The user interface circuitry 602 accesses (e.g., receives, requests, monitors, etc.) inputs to the user interface 114 (e.g., the fixed user interface 114A and/or the portable user interface 114B) of FIGS. 1A and 1B and/or the second user interface 212 of FIG. 2. For example, the user interface circuitry 602 can determine if a user of the vehicle 100 has activated the user interface 114. In some examples, the user interface circuitry 602 can determine whether a user input to the user interface 114 satisfies a criterion. In some such examples, if the user interface 114 is a biometric interface, the user interface circuitry 602 can determine if the user input (e.g., a fingerprint, etc.) is from an authorized user of the vehicle 100. Additionally or alternatively, the user interface 114 can determine if the user input satisfies a quantity criterion (e.g., a button of the user interface 114 has been activated a predetermined quantity of times, etc.), a duration criterion (e.g., a button of the user interface has been activated for a predetermined duration, etc.), a cadence criterion (e.g., a button of the user interface has been activated with a particular cadence, etc.), and/or an order criterion (e.g., have a plurality of buttons of the user interface 114 been activated in a particular order, etc.). In some such examples, if the input to the user interface 114 does not satisfy one or more criteria, the user interface circuitry 602 does not activate and/or deactivate the anti-theft system 102. In some examples, the user interface circuitry 602 is instantiated by programmable circuitry executing user interface instructions and/or configured to perform operations such as those represented by the flowcharts of FIGS. 7 and 8.

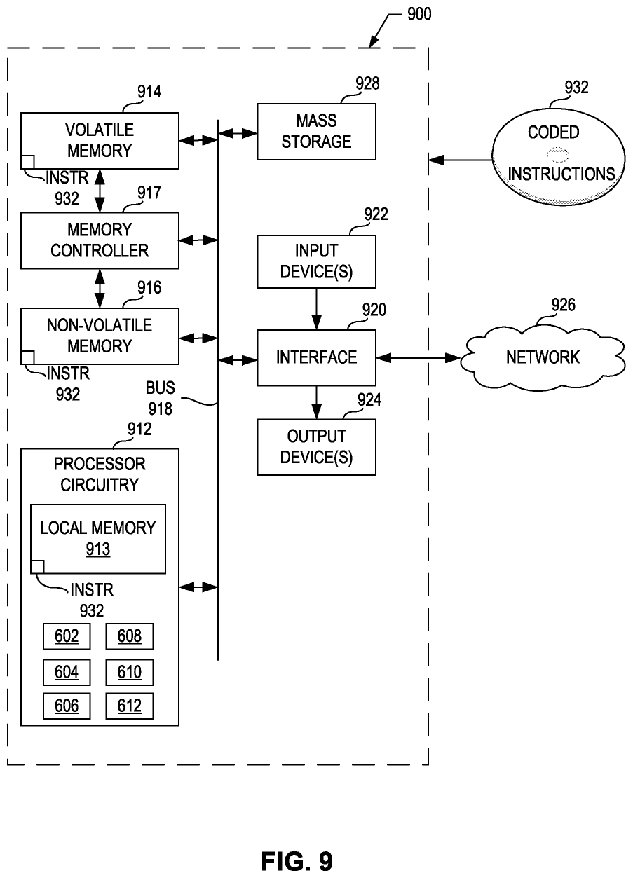

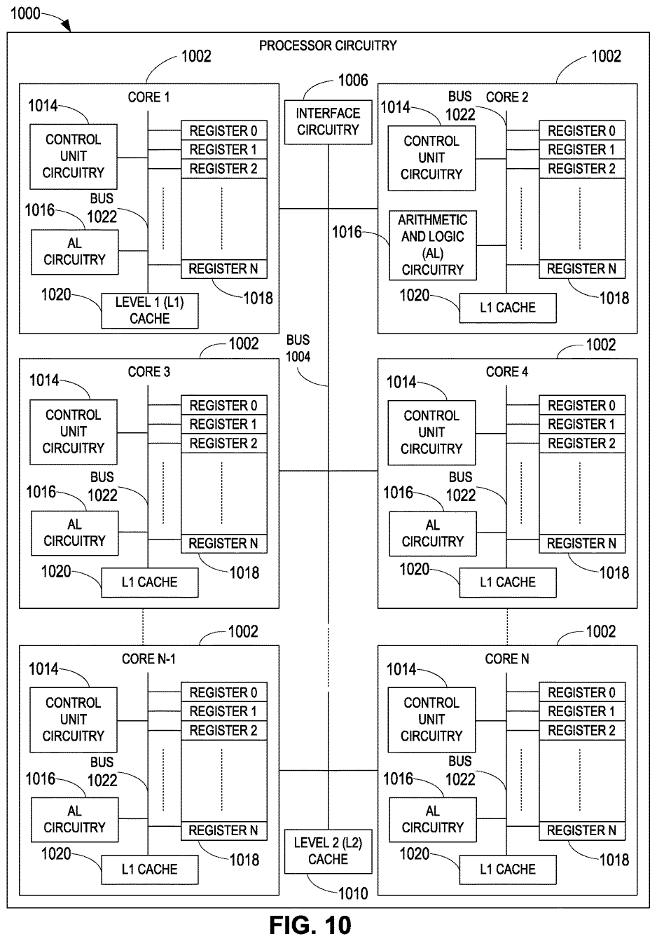

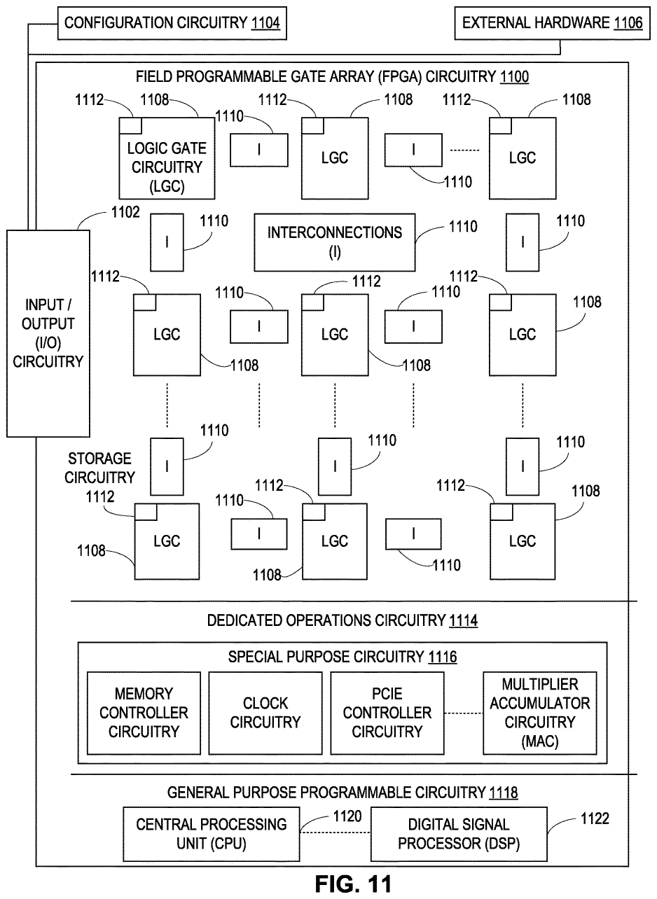

In some examples, the anti-theft controller 128 includes means for detecting a user input. For example, the means for detecting a user input may be implemented by the user interface circuitry 602. In some examples, the user interface circuitry 602 may be instantiated by programmable circuitry such as the example programmable circuitry 912 of FIG. 9. For instance, the user interface circuitry 602 may be instantiated by the example microprocessor 1000 of FIG. 10 executing machine executable instructions such as those implemented by at least blocks 702, 705, 706, 711, 712 of FIG. 7 and/or blocks 805, 806, 811, 812 of FIG. 8. In some examples, the user interface circuitry 602 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the anti-theft controller 128 may be instantiated by any other combination of hardware, software, and/or firmware. For example, the user interface circuitry 602 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The threshold time comparator circuitry 604 determines if the vehicle 100 is to be disabled and/or whether the horn 116 and/or the speaker 117 is to be activated based on a comparison of a time to one or more time thresholds. Additionally or alternatively, if the anti-theft controller 128 is operating in the anti-carjacking mode, the threshold time comparator circuitry 604 can compare a time since the user interface circuitry 602 detected a user input to one or more additional time thresholds. Additionally or alternatively, if the anti-theft controller 128 is operating in the anti-motor theft mode, the threshold time comparator circuitry 604 can compare a time since the fuse box interface circuitry 606 detected the ignition of the vehicle 100 to one or more additional time thresholds. In some examples, if the user interface circuitry 602 detects a user input (e.g., a subsequent user interface, etc.), the threshold time comparator circuitry 604 does not compare the elapsed time to the time thresholds.

In some examples, the threshold time comparator circuitry 604 compares the elapsed time to a first time threshold (e.g., thirty seconds, one minute, etc.). In some such examples, if the threshold time comparator circuitry 604 determines that the elapsed time exceeded the first time threshold, the threshold time comparator circuitry 604 can command the alarm interface circuitry 608 to alert a user that the disabling of the vehicle 100 is imminent and to remind them to activate the user interface 114 to prevent the deactivation thereof. Additionally or alternatively, the threshold time comparator circuitry 604 compares the elapsed time to a second time threshold (e.g., one minute, two minutes, etc.) that is greater than the first time threshold. In some such examples, if the threshold time comparator circuitry 604 determines that the elapsed time exceeded the second time threshold, the threshold time comparator circuitry 604 can command the alarm interface circuitry 608 to activate the horn 116 and/or the speaker 117 and the fuse box interface circuitry 606 to disable the vehicle 100. In some examples, the threshold time comparator circuitry 604 determines the threshold time(s) based on a user setting and/or a manufacturer setting input prior to the ignition of the vehicle 100. In some examples, the threshold time comparator circuitry 604 is instantiated by programmable circuitry executing threshold time comparator instructions and/or configured to perform operations such as those represented by the flowcharts of FIGS. 7 and 8.

In some examples, the anti-theft controller 128 includes means for comparing a time to a threshold. For example, the means for comparing a time to a threshold may be implemented by the threshold time comparator circuitry 604. In some examples, the threshold time comparator circuitry 604 may be instantiated by programmable circuitry such as the example programmable circuitry 912 of FIG. 9. For instance, the threshold time comparator circuitry 604 may be instantiated by the example microprocessor 1000 of FIG. 10 executing machine executable instructions such as those implemented by at least blocks 704, 710 of FIG. 7 and/or blocks 804, 810 of FIG. 8. In some examples, the threshold time comparator circuitry 604 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the threshold time comparator circuitry 604 may be instantiated by any other combination of hardware, software, and/or firmware. For example, the threshold time comparator circuitry 604 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The fuse box interface circuitry 606 interfaces with the fuse box 104 of the vehicle 100. In some examples, the fuse box interface circuitry 606 can disable the vehicle 100 by disabling the fuel pump 108 of the vehicle 100. In some such examples, the fuse box interface circuitry 606 can disable the fuel pump 108 of the vehicle 100 by activating the second relay 210 (e.g., sending a command via the first microcontroller output terminal 218A to open the second relay 210, etc.). In some examples, the fuse box interface circuitry 606 determines to disable the vehicle 100 after the threshold time comparator circuitry 604 determines that the elapsed time satisfies the second time threshold. In some examples, the elapsed time before the disabling of the vehicle 100 enables the authorized user of the vehicle 100 to get away from the unauthorized user, which reduces the likelihood of the unauthorized user physically retaliating against the unauthorized user.

Additionally or alternatively, the fuse box interface circuitry 606 can detect the ignition of the vehicle 100. For example, the fuse box interface circuitry 606 can detect the ignition of the vehicle 100 based on the flow of power from a power source of the vehicle 100 to the fuel pump 108. In some such examples, the fuse box interface circuitry 606 detects the ignition of the vehicle 100 based on the microcontroller 202 of FIG. 2 receiving power from the first microcontroller power input terminal 216A. In some examples, the fuse box interface circuitry 606 is instantiated by programmable circuitry executing fuel pump interface instructions and/or configured to perform operations such as those represented by the flowcharts of FIGS. 7 and 8.

In some examples, the anti-theft controller 128 includes means for interfacing with a fuse box of a vehicle. For example, the means for interfacing with a fuse box of a vehicle may be implemented by the fuse box interface circuitry 606. In some examples, the fuse box interface circuitry 606 may be instantiated by programmable circuitry such as the example programmable circuitry 912 of FIG. 9. For instance, the fuse box interface circuitry 606 may be instantiated by the example microprocessor 1000 of FIG. 10 executing machine executable instructions such as those implemented by at least block 714 of FIG. 7 or at least blocks 802, 814 of FIG. 8. In some examples, the fuse box interface circuitry 606 may be instantiated by hardware logic circuitry, which may be implemented by an ASIC, XPU, or the FPGA circuitry 1100 of FIG. 10 configured and/or structured to perform operations corresponding to the machine readable instructions. Additionally or alternatively, the fuse box interface circuitry 606 may be instantiated by any other combination of hardware, software, and/or firmware. For example, the fuse box interface circuitry 606 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The alarm interface circuitry 608 interfaces with the horn 116, the speaker 117, and/or other alarm systems of the vehicle 100. For example, the alarm interface circuitry 608 can activate the horn 116, the stock horn of the vehicle 100, the speaker 117, and/or the alarm system of the vehicle 100 after the threshold time comparator circuitry 604 determines the second threshold time has been exceeded. In some examples, the alarm interface circuitry 608 activates the horn 116 (and/or the speaker 117) by activating the second relay 210 (e.g., sending a command via the second microcontroller output terminal 218B to close the second relay 210, etc.). In some examples, the activation of the horn 116 enables law enforcement and/or an authorized user of the vehicle 100 to find the vehicle 100 following the disabling of the vehicle 100 by the fuse box interface circuitry 606.

In some examples, the alarm interface circuitry 608 can present the operator of the vehicle with a warning prior to disabling the vehicle 100. For example, the alarm interface circuitry 608 can present a warning to an operator of the vehicle 100 after the threshold time comparator circuitry 604 determines the first time threshold has been exceeded. In some examples, the alarm interface circuitry 608 can activate the horn 116 and/or the speaker 117 to alert a user that the disabling of the vehicle 100 is imminent. In some such examples, the alarm interface circuitry 608 can alert the user with the horn 116 and/or the speaker 117 with a different noise and/or a lower volume than the alert played when the vehicle 100 is disabled. In other examples, the alarm interface circuitry 608 can present a warning to an operator of the vehicle 100 in a different manner (e.g., via a different horn, via a warning light, via an alert on a display of the vehicle 100, via a message sent to the portable device that implemented the portable user interface 114B, etc.). In some examples, the alarm interface circuitry 608 is instantiated by programmable circuitry executing alarm interface instructions and/or configured to perform operations such as those represented by the flowcharts of FIGS. 7 and 8.

In some examples, the anti-theft controller 128 includes means for interfacing with an alarm system. For example, the means for interfacing with an alarm system may be implemented by the alarm interface circuitry 608. In some examples, the alarm interface circuitry 608 may be instantiated by programmable circuitry such as the example programmable circuitry 912 of FIG. 9. For instance, the alarm interface circuitry 608 may be instantiated by the example microprocessor 1000 of FIG. 10 executing machine executable instructions such as those implemented by at least blocks 708, 716 of FIG. 7 and/or blocks 808, 816. In some examples, the alarm interface circuitry 608 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the alarm interface circuitry 608 may be instantiated by any other combination of hardware, software, and/or firmware. For example, the alarm interface circuitry 608 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The GPS interface circuitry 610 interfaces with the GPS 130 of FIG. 1B. In some examples, the GPS interface circuitry 610 accesses an output of the GPS 130 to determine a speed of the vehicle 100. In some examples, the GPS interface circuitry 610 can compare the speed of the vehicle 100 to a threshold (e.g., 0 mph, 5 mph, 40 mph, etc.) to determine if it is safe to disable operation of the vehicle 100. Additionally or alternatively, the GPS interface circuitry 610 can consider other outputs of the GPS 130 to determine if it is safe to disable operation of the vehicle 100 (e.g., a location of the vehicle 100, a trajectory of the vehicle 100, an acceleration of the vehicle 100, etc.). In some examples, the GPS interface circuitry 610 is instantiated by programmable circuitry executing GPS interface instructions and/or configured to perform operations such as those represented by the flowcharts of FIGS. 7 and 8.

In some examples, the anti-theft controller 128 includes means for interfacing with a global positioning system. For example, the means for interfacing with a global positioning system may be implemented by the GPS interface circuitry 610. In some examples, the GPS interface circuitry 610 may be instantiated by programmable circuitry such as the example programmable circuitry 912 of FIG. 9. For instance, the GPS interface circuitry 610 may be instantiated by the example microprocessor 1000 of FIG. 10 executing machine executable instructions such as those implemented by at least block 713 of FIG. 7 and/or block 813 of FIG. 8. In some examples, the GPS interface circuitry 610 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the GPS interface circuitry 610 may be instantiated by any other combination of hardware, software, and/or firmware. For example, the GPS interface circuitry 610 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The portable device detection circuitry 612 detects the presence and/or proximity of an authorized portable device (e.g., the smartphone 115 of FIGS. 1A and 1B). In some examples, the portable device detection circuitry 612 detects an authorized portable device by pairing with the portable device via BLUETOOTH® when the portable device is within communication range. In some such examples, a user must initiate a pairing operation the first time the device is paired with the anti-theft controller 128. Thereafter, in some examples, the anti-theft controller stores the pairing information for future reference so that the pairing occurs automatically whenever the portable device is within communication range. In some cases, a re-pairing operation may be needed to re-establish a connection between the portable device and the anti-theft controller 128. In some examples, the portable device is the same device that implements the portable user interface 114B. In some such examples, the user interface circuitry 602 may implement the functionality of the portable device detection circuitry 612. In some examples, the portable device detection circuitry 612 is instantiated by programmable circuitry executing portable device detection instructions and/or configured to perform operations such as those represented by the flowcharts of FIGS. 7 and 8.

In some examples, the anti-theft controller 128 includes means for detecting the presence of a portable device. For example, the means for detecting the presence of a portable device may be implemented by the portable device detection circuitry 612. In some examples, the portable device detection circuitry 612 may be instantiated by programmable circuitry such as the example programmable circuitry 912 of FIG. 9. For instance, the portable device detection circuitry 612 may be instantiated by the example microprocessor 1000 of FIG. 10 executing machine executable instructions such as those implemented by at least block 803 of FIG. 8. In some examples, the portable device detection circuitry 612 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the portable device detection circuitry 612 may be instantiated by any other combination of hardware, software, and/or firmware. For example, the portable device detection circuitry 612 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the anti-theft controller 128 of FIG. 1B is illustrated in FIG. 6, one or more of the elements, processes, and/or devices illustrated in FIG. 6 may be combined, divided, re-arranged, omitted, eliminated, and/or implemented in any other way. Further, the user interface circuitry 602, the threshold time comparator circuitry 604, the fuse box interface circuitry 606, the alarm interface circuitry 608, the GPS interface circuitry 610, the portable device detection circuitry 612, and/or, more generally, the example anti-theft controller 128 of FIG. 6, may be implemented by hardware alone or by hardware in combination with software and/or firmware. Thus, for example, any of the user interface circuitry 602, the threshold time comparator circuitry 604, the fuse box interface circuitry 606, the alarm interface circuitry 608, the GPS interface circuitry 610, the portable device detection circuitry 612, and/or, more generally, the example anti-theft controller 128, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example anti-theft controller 128 of FIG. 6 may include one or more elements, processes, and/or devices in addition to, or instead of, those illustrated in FIG. 6, and/or may include more than one of any or all of the illustrated elements, processes and devices.

Flowcharts representative of example machine readable instructions, which may be executed by programmable circuitry to implement and/or instantiate the anti-theft controller 128 of FIG. 6 and/or representative of example operations which may be performed by programmable circuitry to implement and/or instantiate the anti-theft controller 128 of FIG. 6, are shown in FIGS. 7 and 8. The machine readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 7 and 8, many other methods of implementing the example anti-theft controller 128 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 7 and 8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine readable instructions and/or example operations 700 that may be executed, instantiated, and/or performed by programmable circuitry to operate the anti-theft system 102 of FIGS. 1A and 1B in an anti-carjacking mode. For example, the operations 700 can occur while the vehicle 100 is in operation.

The example machine-readable instructions and/or the example operations 700 of FIG. 7 begin at block 702, at which the user interface circuitry 602 determines if a user input has been detected. For example, the user interface circuitry 602 can determine if an operator of the vehicle 100 has input a user input via the user interface 114. In some examples, a user can input a user input to the user interface 114 while the vehicle 100 is undergoing a carjacking. In some examples, the user interface circuitry 602 can be configured to detect a biometric input associated with an authorized user (e.g., a vocal input, a fingerprint, a facial scan, etc.) and/or a user input that satisfied one or more predetermined criteria (e.g., a predetermined number of activations of the user interface 114, holding down a button of the user interface 114 for a predetermined amount of time, activating the user interface 114 in a predetermined sequence, activating one or more buttons of the user interface 114 in a predetermined cadence, etc.). In some examples, the user input is provided via a portable device carried by the user. In some such examples, the user input may be provided after the carjacking has already occurred and the user is no longer in the vehicle 100. If the user interface circuitry 602 detects a user input, the operations 700 advance to block 704. If the user interface circuitry 602 does not detect a user input, the operations 700 advance to block 718.

At block 704, the threshold time comparator circuitry 604 determines whether a first threshold time has been exceeded after a user input was detected during the execution of block 702. In some examples, the threshold time comparator circuitry 604 can compare the time that has elapsed since the user input was detected during the execution of block 702 to a threshold determined by a manufacturer of the vehicle 100, a user of the vehicle 100, and/or a manufacturer of the anti-theft system 102. In some examples, the first threshold is between 30 seconds and one minute. In other examples, the first threshold is less than 30 seconds or more than one minute. If the threshold time comparator circuitry 604 determines the first threshold time has been exceeded, the operations 700 advance to block 706. If the threshold time comparator circuitry 604 determines the first threshold time has not been exceeded, the operations 700 advance to block 705.

At block 705, the user interface circuitry 602 determines whether to cancel the anti-carjacking sequence. In some examples, the user interface determines to cancel the sequence based on receiving another user input indicating the sequence is to be canceled. For instance, a user may have inadvertently provided the first user input (detected during the execution of block 702) and, therefore, seeks to stop the process. In other examples, a real carjacking may have started but the thief ended up leaving the car and running away such that the anti-theft system no longer needs to be activated. If the user interface circuitry 602 determines to cancel the anti-carjacking sequence, the operations 700 advance to block 718. If the user interface circuitry 602 determines not to cancel the anti-carjacking sequence, execution of block 704 repeats.

At block 706, the user interface circuitry 602 determines if a subsequent user input has been detected. For example, the user interface circuitry 602 determines if another user input to the user interface 114 has been detected (e.g., in addition to the user input detected during the execution of block 702, etc.). In some examples, the user interface circuitry 602 can determine if the same type of user input detected during the execution of block 702 has been detected (e.g., a same biometric input, a user input of the same duration, a user input with the same quantity of user inputs, etc.). In some examples, the user input can indicate user intent to cancel the anti-carjacking sequence. If the user interface circuitry 602 detects a subsequent user input, the operations 700 advance to block 718. If the user interface circuitry 602 does not detect a subsequent user input, the operations 700 advance to block 708.

At block 708, the alarm interface circuitry 608 presents the operator of the vehicle with a warning. For example, the alarm interface circuitry 608 can activate an audio generator (e.g., the horn 116, the speaker 117, and/or the audio generator 308) to alert a user that the disabling of the vehicle 100 is imminent. In some examples, the warning is a horn blast (e.g., from the horn 116). In some examples, the warning is a voice message output by the speaker 117. In some such examples, the warning is ongoing until a second threshold time is reached. For instance, in some examples, the warning includes an audible countdown until the second threshold time is reached. In other examples, the alarm interface circuitry 608 can present a warning to an operator of the vehicle 100 in a different manner (e.g., via a warning light, via an alert on a display of the vehicle 100, via an alert on a display of a portable device, etc.). In some examples, the execution of blocks 704, 706, 708 are excluded. That is, in some examples, a user of the vehicle 100 is not presented with a warning prior to the deactivation of the fuel pump 108. In some such examples, the operations 700 proceed directly from block 702 to 710 after the user interface circuitry 602 detects a user input.

At block 710, the threshold time comparator circuitry 604 determines whether a second threshold time has been exceeded after a user input was detected during the execution of block 702. In some examples, the threshold time comparator circuitry 604 can compare the time elapsed since the determined user input was detected during the execution of block 702 to a second threshold determined by a manufacturer of the vehicle 100, a user of the vehicle 100, and/or a manufacturer of the anti-theft system 102. In some examples, the second threshold is greater than the first threshold associated with the execution of block 704. In some examples, the second threshold is between one minute and two minutes. In other examples, the second threshold is less than one minute or more than two minutes. If the threshold time comparator circuitry 604 determines the second threshold time has been exceeded, the operations 700 advance to block 712. If the threshold time comparator circuitry 604 determines the first threshold time has not been exceeded, the operations 700 advance to block 711.

At block 711, the user interface circuitry 602 determines whether to cancel the anti-carjacking sequence. In some examples, the user interface determines to cancel the sequence based on receiving another user input indicating the sequence is to be canceled. For instance, a user may have inadvertently provided the first user input (detected during the execution of block 702) but not realized it until the warning (presented during the execution of block 708) and, therefore, seeks to stop the process. In other examples, a real carjacking may have started but the thief ended up leaving the car and running away such that the anti-theft system no longer needs to be activated. If the user interface circuitry 602 determines to cancel the anti-carjacking sequence, the operations 700 advance to block 718. If the user interface circuitry 602 determines not to cancel the anti-carjacking sequence, execution of block 710 repeats.

At block 712, the user interface circuitry 602 determines if a subsequent user input has been detected. For example, the user interface circuitry 602 can determine if another user input has been detected in a manner similar to the execution of block 706. In some examples, the user input can indicate user intent to cancel the anti-carjacking sequence. If the user interface circuitry 602 detects a subsequent user input, the operations 700 advance to block 718. If the user interface circuitry 602 does not detect a subsequent user input, the operations 700 advance to block 713.

At block 713, the GPS interface circuitry 610 determines if the vehicle 100 is operating below a threshold speed. For example, the GPS interface circuitry 610 can interface with the GPS 130 of FIG. 1 to determine a speed of the vehicle 100. In some examples, the GPS interface circuitry 610 can compare the speed of the vehicle 100 to a speed threshold (e.g., 0 mph, 5 mph, 15 mph, 40 mph, etc.). If the GPS interface circuitry 610 determines the vehicle 100 is operating below a threshold speed, the operations 700 advance to block 714. If the GPS interface circuitry 610 determines the vehicle 100 is operating below a threshold speed, the execution of block 713 repeats. In some examples, the execution of block 713 is omitted (e.g., the operations 700 advance directly from block 712 to block 714, etc.).

At block 714, the alarm interface circuitry 608 activates the audio generator (e.g., the horn 116, the speaker 117, and/or the audio generator 308). For example, the alarm interface circuitry 608 can activate the audio generator by activating the second relay 210 (e.g., sending a command via the second microcontroller output terminal 218B to close the second relay 210, etc.). Additionally or alternatively, the alarm interface circuitry 608 can activate the stock horn of the vehicle 100, the stock speaker(s) of the vehicle 100, and/or the stock alarm system of the vehicle 100. In some examples, the activation of the audio generator (e.g., blasting of the horn 116) enables law enforcement and/or an authorized user of the vehicle 100 to find the vehicle 100 following the disabling of the vehicle 100 following the execution of block 714.

At block 716, the fuse box interface circuitry 606 disables the fuel pump 108 of the vehicle 100. For example, the fuse box interface circuitry 606 can disable the fuel pump 108 of the vehicle 100 by activating the first relay 208 (e.g., sending a command via the first microcontroller output terminal 218A to open the first relay 208, etc.). In some examples, the disabling of the fuel pump 108 renders the vehicle 100 inoperable and prevents an unauthorized user of the vehicle 100 from further operating the vehicle 100.

At block 718, the user interface circuitry 602 and/or the fuse box interface circuitry 606 determines if the user interface circuitry 602 is to continue monitoring for user inputs. For example, the fuse box interface circuitry 606 can determine whether to continue monitoring for user inputs if the vehicle 100 is still in operation (e.g., if the assembly 300 is receiving power from the fuse box 104, if the engine 110 is in operation, etc.). Additionally or alternatively, the user interface circuitry 602 can determine whether to continue monitoring for user inputs based on a user input (e.g., a user input to the user interface 114, etc.). If the user interface circuitry 602 and/or the fuse box interface circuitry 606 determines monitoring is to continue, the operations 700 return to block 702. If the user interface circuitry 602 and/or the fuse box interface circuitry 606 determines monitoring is not to continue, the operations 700 end.

FIG. 8 is a flowchart representative of example machine readable instructions and/or example operations 800 that may be executed, instantiated, and/or performed by programmable circuitry to operate the anti-theft system 102 of FIGS. 1A and 1B in an anti-motor theft mode. The example machine-readable instructions and/or the example operations 800 of FIG. 8 begin at block 802, at which the fuse box interface circuitry 606 detects the ignition of the vehicle 100. For example, the fuse box interface circuitry 606 can detect the ignition of the vehicle 100 based on the microcontroller 202 of FIG. 2 receiving power from the first microcontroller power input terminal 216A. In other examples, the fuse box interface circuitry 606 can detect the ignition of the vehicle 100 in any other suitable method (e.g., via a sensor, by interfacing with a vehicle system, etc.).

At block 803, the portable device detection circuitry 612 determines whether an authorized portable device is in proximity to the vehicle 100. In some examples, the portable device detection circuitry 612 scans for whitelisted portable devices that have previously paired with the receiver module 112 and are within communication range of the receiver module 112. In some examples, if an authorized portable device is detected in proximity to the vehicle 100, it can be inferred that the vehicle ignition detected during the execution of block 802 was initiated by an authorized user carrying the portable device such that the anti-motor theft sequence can be stopped without requiring an explicit input by the user. Thus, if the portable device detection circuitry 612 determines that an authorized portable device is in proximity to the vehicle 100, the operations 800 end. If the portable device detection circuitry 612 does not detect an authorized portable device in proximity to the vehicle 100, the operations 800 advance to block 804. In some examples, block 803 is omitted such that the anti-theft mode sequence is initiated regardless of whether a portable device is detected in proximity to the vehicle 100.

At block 804, the threshold time comparator circuitry 604 determines whether a first threshold time has been exceeded after a vehicle ignition was detected during the execution of block 802. In some examples, the threshold time comparator circuitry 604 can compare the time elapsed since vehicle ignition to a threshold determined by a manufacturer of the vehicle 100, a user of the vehicle 100, and/or a manufacturer of the anti-theft system 102. In some examples, the first threshold is between 30 seconds and one minute. In other examples, the first threshold is less than 30 seconds or more than one minute. If the threshold time comparator circuitry 604 determines the first threshold time has been exceeded, the operations 800 advances to block 806. If the threshold time comparator circuitry 604 determines the first threshold time has not been exceeded, the operations 800 advance to block 805.

At block 805, the user interface circuitry 602 determines whether to cancel the anti-motor theft sequence. In some examples, the user interface determines to cancel the sequence based on receiving a user input indicating the sequence is to be canceled. If the user interface circuitry 602 determines to cancel the anti-motor theft sequence, the operations 800 end. If the user interface circuitry 602 determines not to cancel the anti-motor theft sequence, execution of block 804 repeats.

At block 806, the user interface circuitry 602 determines if a user input has been detected. For example, the user interface circuitry 602 can determine whether a user input to the user interface 114 has been detected. In some examples, the user interface circuitry 602 can be configured to detect a biometric input associated with an authorized user (e.g., a vocal input, a fingerprint, a facial scan, etc.) and/or a user input that satisfied one or more predetermined criteria (e.g., a predetermined number of activations of the user interface 114, holding down a button of the user interface 114 for a predetermined amount of time, activating the user interface 114 in a predetermined cadence, etc.). In some examples, the user input can indicate user intent to cancel the anti-motor theft sequence. If the user interface circuitry 602 detects a user input, the operations 800 end. If the user interface circuitry 602 does not detect a user input, the operations 800 advance to block 808.

At block 808, the alarm interface circuitry 608 presents the operator of the vehicle with a warning. For example, the alarm interface circuitry 608 can activate an audio generator (e.g., the horn 116, the speaker 117, and/or the audio generator 308) to alert a user that the disabling of the vehicle 100 is imminent. In some examples, the warning is a horn blast. In some examples, the warning is a voice message output by one or more speakers. In some such examples, the warning is ongoing until a second threshold time is reached. For instance, in some examples, the warning includes an audible countdown until the second threshold time is reached. In other examples, the alarm interface circuitry 608 can present a warning to an operator of the vehicle 100 in a different manner (e.g., via a warning light, via an alert on a display of the vehicle 100, via an alert on a display of a portable device, etc.). In some examples, the execution of blocks 804, 806, 808 are excluded. That is, in some examples, a user of the vehicle 100 is not presented with a warning prior to the deactivation of the fuel pump 108. In some such examples, the operations 800 proceed directly from block 802 to 810.

At block 810, the threshold time comparator circuitry 604 determines a second threshold time has been exceeded after vehicle ignition was detected during the execution of block 802. In some examples, the threshold time comparator circuitry 604 can compare elapsed time to a second threshold determined by a manufacturer of the vehicle 100, a user of the vehicle 100, and/or a manufacturer of the anti-theft system 102. In some examples, the second threshold is greater than the first threshold associated with the execution of block 704. In some examples, the second threshold is between one minute and two minutes. In other examples, the second threshold is less than one minute or more than two minutes. If the threshold time comparator circuitry 604 determines the second threshold time has been exceeded, the operations 800 advance to block 812. If the threshold time comparator circuitry 604 determines the first threshold time has not been exceeded, the operations 800 advance to block 811.

At block 811, the user interface circuitry 602 determines whether to cancel the anti-motor theft sequence. In some examples, the user interface determines to cancel the sequence based on receiving a user input indicating the sequence is to be canceled. If the user interface circuitry 602 determines to cancel the anti-motor theft sequence, the operations 800 end. If the user interface circuitry 602 determines not to cancel the anti-motor theft sequence, execution of block 810 repeats.

At block 812, the user interface circuitry 602 determines if a subsequent user input has been detected. For example, the user interface circuitry 602 can determine whether a user input has been detected in a manner similar to the execution of block 806. In some examples, the user input can indicate user intent to cancel the anti-motor theft sequence. If the user interface circuitry 602 detects a user input, the operations 800 advance to block 814. If the user interface circuitry 602 does not detect a subsequent user input, the operations 800 advance to block 813.

At block 813, the GPS interface circuitry 610 determines if the vehicle 100 is operating below a threshold speed. For example, the GPS interface circuitry 610 can interface with the GPS 130 of FIG. 1 to determine a speed of the vehicle 100. In some examples, the GPS interface circuitry 610 can compare the speed of the vehicle 100 to a speed threshold (e.g., 0 mph, 5 mph, 15 mph, 40 mph, etc.). If the GPS interface circuitry 610 determines the vehicle 100 is operating below a threshold speed, the operations 800 advance to block 814. If the GPS interface circuitry 610 determines the vehicle 100 is operating below a threshold speed, the execution of block 813 repeats. In some examples, the execution of block 813 is omitted (e.g., the operations 800 advance directly from block 812 to block 814, etc.).

At block 814, the alarm interface circuitry 608 activates the audio generator (e.g., the horn 116, the speaker 117, and/or the audio generator 308). For example, the alarm interface circuitry 608 can activate the audio generator by activating the second relay 210 (e.g., sending a command via the second microcontroller output terminal 218B to close the second relay 210, etc.). Additionally or alternatively, the alarm interface circuitry 608 can activate the stock horn of the vehicle 100 and/or the alarm system of the vehicle 100. In some examples, the activation of the audio generator (e.g., blasting the horn 116) enables law enforcement and/or an authorized user of the vehicle 100 to find the vehicle 100 following the disabling of the vehicle 100 following the execution of block 814.

At block 816, the fuse box interface circuitry 606 disables the fuel pump 108 of the vehicle 100. For example, the fuse box interface circuitry 606 can disable the fuel pump 108 of the vehicle 100 by activating the first relay 208 (e.g., sending a command via the first microcontroller output terminal 218A to open the first relay 208, etc.). In some examples, the disabling of the fuel pump 108 renders the vehicle 100 inoperable and prevents an unauthorized user of the vehicle 100 from further operating the vehicle 100. Thereafter, the operations 800 end.

FIG. 9 is a block diagram of an example programmable circuitry platform 900 structured to execute and/or instantiate the example machine-readable instructions and/or the example operations of FIGS. 7 and 8 to implement the anti-theft controller 128 of FIG. 6. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a Blu-ray player, a gaming console, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, VPUs, DSPs, and/or microcontrollers from any desired family or manufacturer. The programmable circuitry 912 may be implemented by one or more semiconductor based (e.g., silicon based) devices. In this example, the programmable circuitry 912 implements the user interface circuitry 602, the threshold time comparator circuitry 604, the fuse box interface circuitry 606, the alarm interface circuitry 608, the GPS interface circuitry 610, and the portable device detection circuitry 612.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 7 and 8, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 7 and 8 to effectively instantiate the circuitry of FIG. 6 as logic circuits to perform operations corresponding to those machine readable instructions. In some such examples, the circuitry of FIG. 6 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 7 and 8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry 1016 (sometimes referred to as an ALU), a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 7 and 8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 7 and 8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 7 and 8. As such, the FPGA circuitry 1100 may be configured and/or structured to effectively instantiate some or all of the operations/functions corresponding to the machine readable instructions of the flowcharts of FIGS. 7 and 8 as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIGS. 7 and 8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof. In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIGS. 7 and 8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 11. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine readable instructions represented by the flowcharts of FIGS. 7 and 8 to perform first operation(s)/function(s), the FPGA circuitry 1100 of FIG. 11 may be configured and/or structured to perform second operation(s)/function(s) corresponding to a second portion of the machine readable instructions represented by the flowcharts of FIGS. 7 and 8, and/or an ASIC may be configured and/or structured to perform third operation(s)/function(s) corresponding to a third portion of the machine readable instructions represented by the flowcharts of FIGS. 7 and 8.

It should be understood that some or all of the circuitry of FIG. 6 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 6 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 6 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated by those having ordinary skill in the art that example systems, apparatus, articles of manufacture, and methods have been disclosed that disable a vehicle after theft. Examples disclosed prevent operation of a vehicle after a carjacking and/or motor theft and alert law enforcement to the location of the vehicles. Example anti-theft systems disclosed herein disable a fuel pump of a vehicle after a delay from the theft of the vehicle, which creates distance between the thief and the authorized user of the vehicle. Examples disclosed herein offer increased safety for authorized users of vehicles and reduce the likelihood of physical retribution from thieves when compared to prior anti-theft systems.

Methods and apparatus to disable a vehicle after theft are disclosed herein. Further examples and combinations thereof include the following:
Example 1 includes a system including a receiver connected to a user interface, and a controller including a first connection to be connected to the receiver, a second connection to be connected to a fuse box of a vehicle, the fuse box coupled to a fuel pump of the vehicle, and a relay to disable the fuel pump of the vehicle.
Example 2 includes the system of any preceding example, wherein the controller is to detect an ignition of the vehicle, and in response to determining the user interface has not received a user input after a threshold time, disable the fuel pump.
Example 3 includes the system of any preceding example, wherein the user input includes activating a button with a predetermined quantity of presses, the predetermined quantity greater than one.
Example 4 includes the system of any preceding example, wherein the user input includes activating a button for a predetermined duration.
Example 5 includes the system of any preceding example, wherein the controller is to detect a user input to the user interface while the vehicle is in operation, and disable the fuel pump after a threshold time.
Example 6 includes the system of any preceding example, wherein the threshold time is at least 30 seconds.
Example 7 includes the system of any preceding example, wherein the controller is to determine the threshold time based on a user setting, the user setting input prior to ignition of the vehicle.
Example 8 includes the system of any preceding example, wherein the user interface includes a biometric interface.
Example 9 includes the system of any preceding example, wherein the user interface is wirelessly connected to the receiver.
Example 10 includes the system of any preceding example, including a horn coupled to the controller.
Example 11 includes the system of any preceding example, wherein the relay is a first relay, the controller includes a second relay to activate the horn.
Example 12 includes the system of any preceding example, wherein the controller is to activate the horn before the fuel pump is disabled.
Example 13 includes the system of any preceding example, including a voltage regulator and a fuse disposed between the controller and the fuse box.
Example 14 includes the system of any preceding clause, wherein the user interface is to be provided by a mobile app installed on a portable device distinct from the vehicle.
Example 15 includes the system of any preceding clause, wherein the controller is to prevent the disabling of the fuel pump based on detection of the portable device in proximity to the vehicle.
Example 16 includes the system of any preceding clause, wherein the detection of the portable device is based on at least one of a BLUETOOTH® or BLUETOOTH LOW ENERGY (BLE) connection with the portable device
Example 17 includes the system of any preceding clause, including a speaker coupled to the controller, the speaker to at least one of announce a current state of the system, announce a warning that a shutdown sequence of the vehicle is pending, announce a countdown timer until the vehicle is shutdown, or generate a chime to confirm at least one of receipt of a command or detection of authorization via a portable device.
Example 18 includes an apparatus to operate an anti-theft system for a vehicle, comprising interface circuitry, machine readable instructions, and at least one programmable circuit to at least one of instantiate or execute the machine readable instructions to initiate a timer in response to an event indicative of a theft of the vehicle, and in response to the timer exceeding a threshold time, causing a fuel pump of the vehicle to be disabled.
Example 19 includes the apparatus of any preceding clause, wherein the event corresponds to detection of a user input provided via a user interface.
Example 20 includes the apparatus of any preceding clause, wherein the user input is a first user input, and one or more of the at least one programmable circuit is to prevent the fuel pump from being disabled in response to detection of a second user input provided via the user interface, the second user input detected after the first user input and before the timer exceeds the threshold time.
Example 21 includes the apparatus of any preceding clause, wherein the event corresponds to detection of an ignition of the vehicle.
Example 22 includes the apparatus of any preceding clause, wherein one or more of the at least one programmable circuit is to prevent the fuel pump from being disabled in response to detecting an authorized portable device in proximity to the vehicle at a time of the ignition of the vehicle.
Example 23 includes the apparatus of any preceding clause, wherein one or more of the at least one programmable circuit is to prevent the fuel pump from being disabled in response to detection of a user input provided via a user interface before the timer exceeds the threshold time.
Example 24 includes the apparatus of any preceding clause, wherein the threshold time is a first threshold time, and one or more of the at least one programmable circuit is to generate a warning in response to the timer exceeding a second threshold time, the first threshold time greater than the second threshold time, the warning to indicate the vehicle is to be disabled.
Example 25 includes the apparatus of any preceding clause, wherein one or more of the at least one programmable circuit is to monitor a speed of the vehicle and wait until the vehicle is below a threshold speed before causing the fuel pump to be disabled.
Example 26 includes the apparatus of any preceding clause, wherein one or more of the at least one programmable circuit is to activate a horn when the fuel pump is disabled.
Example 27 includes a non-transitory machine readable storage medium comprising instructions to cause at least one programmable circuit to at least initiate a timer in response to an event indicative of a theft of a vehicle, and in response to the timer exceeding a threshold time, causing a fuel pump of the vehicle to be disabled.
Example 28 includes the non-transitory machine readable storage medium of any preceding clause, wherein the event corresponds to detection of a user input provided via a user interface.
Example 29 includes the non-transitory machine readable storage medium of any preceding clause, wherein the user input is a first user input, and the instructions cause one or more of the at least one programmable circuit to prevent the fuel pump from being disabled in response to detection of a second user input provided via the user interface, the second user input detected after the first user input and before the timer exceeds the threshold time.
Example 30 includes the non-transitory machine readable storage medium of any preceding clause, wherein the event corresponds to detection of an ignition of the vehicle.
Example 31 includes the non-transitory machine readable storage medium of any preceding clause, wherein the instructions cause one or more of the at least one programmable circuit to prevent the fuel pump from being disabled in response to detecting an authorized portable device in proximity to the vehicle at a time of the ignition of the vehicle.
Example 32 includes the non-transitory machine readable storage medium of any preceding clause, wherein the instructions cause one or more of the at least one programmable circuit to prevent the fuel pump from being disabled in response to detection of a user input provided via a user interface before the timer exceeds the threshold time.
Example 33 includes the non-transitory machine readable storage medium of any preceding clause, wherein the threshold time is a first threshold time, and the instructions are to cause one or more of the at least one programmable circuit to generate a warning in response to the timer exceeding a second threshold time, the first threshold time greater than the second threshold time, the warning to indicate the vehicle is to be disabled.
Example 34 includes the non-transitory machine readable storage medium of any preceding clause, wherein the instructions are to cause one or more of the at least one programmable circuit to monitor a speed of the vehicle and wait until the vehicle is below a threshold speed before causing the fuel pump to be disabled.
Example 35 includes the non-transitory machine readable storage medium of any preceding clause, wherein the instructions are to cause one or more of the at least one programmable circuit to activate a horn when the fuel pump is disabled.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A system including:
a receiver connected to a user interface; and
a controller including:
a first connection to be connected to the receiver;
a second connection to be connected to a fuse box of a vehicle, the fuse box coupled to a fuel pump of the vehicle; and
a relay to disable the fuel pump of the vehicle.

2. The system of claim 1, wherein the controller is to:
detect an ignition of the vehicle; and
in response to determining the user interface has not received a user input after a threshold time, disable the fuel pump.

3. (canceled)

4. (canceled)

5. The system of claim 1, wherein the controller is to:
detect a user input to the user interface while the vehicle is in operation; and
disable the fuel pump after a threshold time.

6. The system of claim 5, wherein the threshold time is at least 30 seconds.

7. (canceled)

8. (canceled)

9. The system of claim 1, wherein the user interface is wirelessly connected to the receiver.

10. The system of claim 1, including a horn coupled to the controller.

11. The system of claim 10, wherein the relay is a first relay, the controller includes a second relay to activate the horn.

12. (canceled)

13. The system of claim 1, including a voltage regulator and a fuse disposed between the controller and the fuse box.

14. The system of claim 1, wherein the user interface is to be provided by a mobile app installed on a portable device distinct from the vehicle.

15. The system of claim 14, wherein the controller is to prevent the disabling of the fuel pump based on detection of the portable device in proximity to the vehicle.

16. The system of claim 15, wherein the detection of the portable device is based on at least one of a BLUETOOTH® or BLUETOOTH LOW ENERGY (BLE) connection with the portable device.

17. The system of claim 1, including a speaker coupled to the controller, the speaker to at least one of announce a current state of the system, announce a warning that a shutdown sequence of the vehicle is pending, announce a countdown timer until the vehicle is shutdown, or generate a chime to confirm at least one of receipt of a command or detection of authorization via a portable device.

18. An apparatus to operate an anti-theft system for a vehicle, comprising:
interface circuitry;
machine readable instructions; and
at least one programmable circuit to at least one of instantiate or execute the machine readable instructions to:
initiate a timer in response to an event indicative of a theft of the vehicle; and
in response to the timer exceeding a threshold time, causing a fuel pump of the vehicle to be disabled.

19. The apparatus of claim 18, wherein the event corresponds to detection of a user input provided via a user interface.

20. The apparatus of claim 19, wherein the user input is a first user input, and one or more of the at least one programmable circuit is to prevent the fuel pump from being disabled in response to detection of a second user input provided via the user interface, the second user input detected after the first user input and before the timer exceeds the threshold time.

21. The apparatus of claim 18, wherein the event corresponds to detection of an ignition of the vehicle.

22. The apparatus of claim 21, wherein one or more of the at least one programmable circuit is to prevent the fuel pump from being disabled in response to detecting an authorized portable device in proximity to the vehicle at a time of the ignition of the vehicle.

23. The apparatus of claim 21, wherein one or more of the at least one programmable circuit is to prevent the fuel pump from being disabled in response to detection of a user input provided via a user interface before the timer exceeds the threshold time.

24. The apparatus of claim 18, wherein the threshold time is a first threshold time, and one or more of the at least one programmable circuit is to generate a warning in response to the timer exceeding a second threshold time, the first threshold time greater than the second threshold time, the warning to indicate the vehicle is to be disabled.

25. (canceled)

26. (canceled)

27. A non-transitory machine readable storage medium comprising instructions to cause at least one programmable circuit to at least:
initiate a timer in response to an event indicative of a theft of a vehicle; and
in response to the timer exceeding a threshold time, causing a fuel pump of the vehicle to be disabled.

28-35. (canceled)
